(19) United States
(12) Patent Application Publication
(10) Pub. No.: US 2026/0289185 A1
(43) Pub. Date: Sep. 24, 2026

(54) SYSTEM

(71) Applicant: SoftBank Group Corp., Tokyo (JP)

(72) Inventor: Shuji OSATO, Tokyo (JP)

(73) Assignee: SoftBank Group Corp., Tokyo (JP)

(21) Appl. No.: 19/568,935

(22) Filed: Mar. 17, 2026

(30) Foreign Application Priority Data
Mar. 19, 2025 (JP) 2025-045210

(51) Int. Cl. G06F 40/40; G06F 40/174; G06F 40/295; G06F 40/35; G06N 3/0475; G10L 15/18; G10L 25/63; G10L 25/90

(52) U.S. Cl. CPC G06F 40/40; G06F 40/174; G06F 40/295; G06F 40/35; G06N 3/0475; G10L 15/1807; G10L 25/63; G10L 25/90

(57) ABSTRACT

A system includes a processor that is configured to convert speech of a user into text by using a speech recognition technique in order to understand a request or a schedule from a dialogue with the user, wherein the processor is configured to analyze the converted text by using a natural language processing technique and to extract the request or the schedule, and wherein the processor is configured to use a generative AI model to generate a prompt for instructing an appropriate operation based on the extracted request or schedule.

### CROSS-REFERENCE TO RELATED APPLICATION

This application is based on and claims priority under 35 USC 119 from Japanese Patent Application No. 2025-045210 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dialogue systems that interact with users through voice and text often handle speech recognition, natural language understanding, and execution of services as independent or loosely coupled components. In such systems, a first module converts speech to text, a second module analyzes the text to identify user requests or schedules, and a third module executes fixed, rule-based actions. As a result, the overall system lacks flexibility and adaptability when dealing with diverse and ambiguous user expressions, and it is difficult to generate appropriate and context-sensitive instructions for downstream services. Furthermore, many existing systems do not effectively analyze user emotions, and therefore cannot tailor proposed services or responses according to the emotional state of the user. In addition, conventional systems often require explicit and rigid commands to interact with external systems for reservation management, schedule management, information provision, and task assignment, which limits automation and increases the burden on the user. Accordingly, there is a need for a unified system in which a processor seamlessly performs speech recognition, natural language processing, prompt generation using a generative AI model, emotion analysis, and cooperation with external systems, so that more appropriate and flexible operations can be instructed and executed based on user requests, schedules, and emotions.

### SUMMARY

In order to solve the above-described problems, an embodiment of the present invention provides a system comprising a processor, wherein the processor is configured to convert speech of a user into text by using a speech recognition technique in order to understand a request or a schedule from a dialogue with the user. The processor is further configured to analyze the converted text by using a natural language processing technique and to extract the request or the schedule. The processor is further configured to use a generative AI model to generate a prompt for instructing an appropriate operation based on the extracted request or schedule. By generating such a prompt, the processor can flexibly describe desired operations in a machine-interpretable and human-understandable manner, even when the user's expressions are ambiguous or varied. In another aspect, the processor is configured to analyze an emotion of the user, for example based on linguistic features of the converted text or auxiliary data, and to propose a service based on the analyzed emotion, thereby enabling responses and service proposals that are adapted to the user's emotional state. In a further aspect, the processor is configured to cooperate with an external system by using the generated prompt in order to perform at least one of management of a reservation or a schedule, provision of information, and assignment of a task. Through this configuration, the system can automatically and dynamically interact with various external services, such as calendar systems, information services, and task management systems, using the generated prompt as an interface, thereby reducing the operational burden on the user and improving the flexibility and efficiency of user support.

The term “processor” refers to one or more hardware processing units, such as a central processing unit (CPU), a graphics processing unit (GPU), an application-specific integrated circuit (ASIC), or a combination thereof, that executes instructions to perform functions of the system.

The term “speech recognition technique” refers to a technique or algorithm that processes audio signals representing speech of a user and outputs corresponding textual data, and may include acoustic modeling, language modeling, and decoding processes.

The term “natural language processing technique” refers to a technique or algorithm that analyzes textual data expressed in a natural language to identify linguistic structures, meanings, or intents, and may include tokenization, part-of-speech tagging, syntactic parsing, semantic analysis, intent classification, and entity extraction.

The term “generative AI model” refers to a machine learning model, such as a neural network-based model, that generates output data, including but not limited to text, based on input data, and is capable of producing new content such as prompts or instructions conditioned on user requests or schedules.

The term “prompt” refers to a piece of data, typically textual data, generated by the processor and used to describe or instruct a desired operation to be performed by the system or an external system, and which may include commands, parameters, and contextual information.

The term “dialogue with the user” refers to an interaction between the system and the user that involves one or more exchanges of information using speech, text, or both, and that may be conducted in real time or asynchronously.

The term “request” refers to an expression by the user, in speech or text, that indicates a desired operation or service, such as creating an appointment, retrieving information, or assigning a task.

The term “schedule” refers to time-related information expressed by the user, including dates, times, time ranges, or recurring patterns, that is associated with events such as reservations, meetings, or tasks.

The term “emotion of the user” refers to an estimated emotional state of the user, such as happiness, sadness, anger, or stress, that is inferred by the processor based on analysis of user input or related data.

The term “service” refers to a function or operation provided to the user by the system or an external system, including but not limited to reservation management, schedule management, information provision, and task assignment.

The term “external system” refers to a system or service distinct from the claimed system, such as a calendar service, an information service, or a task management service, that can be accessed via a communication interface or an application programming interface (API).

The term “management of a reservation or a schedule” refers to operations performed on reservation or schedule data, including creating, modifying, canceling, or querying events, appointments, or bookings.

The term “provision of information” refers to operations in which the system or an external system obtains, selects, and outputs information to the user in response to a request, such as retrieving web content, database records, or service descriptions.

The term “assignment of a task” refers to operations in which the system creates or updates task data, including specifying a task description, a due date, or an assignee, and optionally registering such data in a task management application or external system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

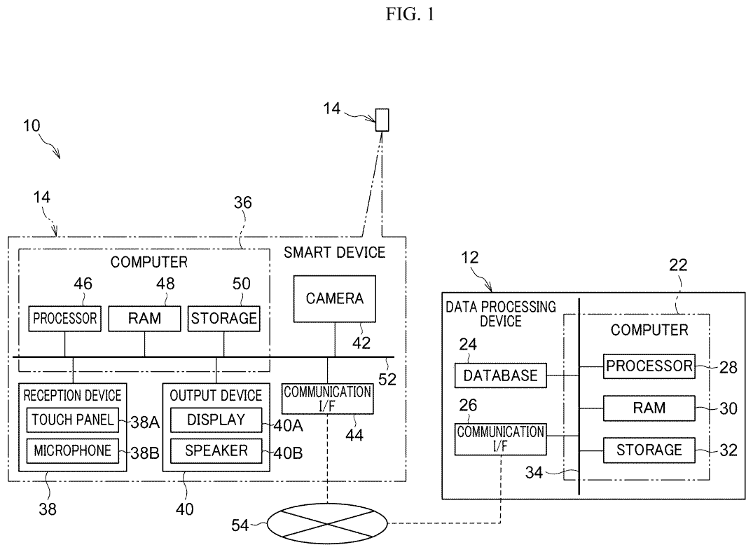

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

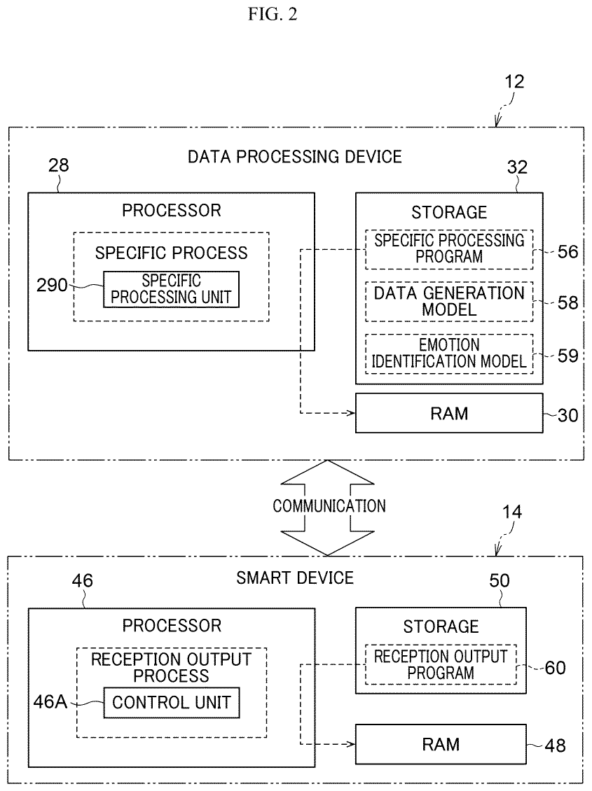

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional schedule management and task automation systems that rely on fixed rule engines or keyword matching suffer from limited accuracy when interpreting diverse natural language utterances from users. In particular, such systems typically require the user to conform to rigid input formats and do not robustly handle noisy input including extraneous characters, irregular spacing, or informal expressions. As a result, the systems frequently fail to extract correct time information and event descriptions, leading to erroneous or incomplete schedule registration.

Moreover, existing systems that integrate natural language interfaces with external services often embed all interpretation logic directly in application code or rely on simple application programming interfaces to a language model without a well-defined separation between preprocessing, prompt construction, semantic analysis, and structured data generation. This architecture makes it difficult to reliably trace how user input is transformed into stored schedule data, to handle ambiguity resolution in a systematic way, or to enforce consistency in how schedule information objects are generated and stored. In addition, conventional client-server arrangements do not provide a robust mechanism for iterative clarification with the user when the initial natural language input is ambiguous or lacks essential schedule elements, which degrades the reliability of automated scheduling.

From a computer technology standpoint, there is a need to improve how a server-side processor orchestrates the flow of data from raw user input, through text normalization and generative artificial intelligence processing, to the generation and storage of structured schedule information. Specifically, there is a need for: (i) a standardized preprocessing pipeline that converts heterogeneous natural language input into analysis-ready text; (ii) a controlled mechanism for constructing prompt sentences and interacting with a generative AI model as an external computational resource; (iii) a deterministic mapping from model output into internal schedule information objects suitable for database storage and external service integration; and (iv) an integrated clarification loop that uses additional prompts and model-generated queries to reduce ambiguity. Without such a structured, computer-centric architecture, server systems cannot reliably and efficiently transform unstructured conversational input into consistent, machine-actionable schedule data while maintaining traceability and scalability.

The specific processing by the specific processing unit 290 of the data processing device 12 in Example 1 is realized by the following means.

The present invention provides a server comprising a processor configured to receive, via an information processing terminal operated by a user, input information expressed in natural language; preprocess the input information by removing unnecessary elements and normalizing character information to generate analysis text information; construct a prompt sentence by embedding the analysis text information into an instruction template; transmit the prompt sentence to a generative information processing model executed on an external information processing apparatus and obtain structured information representing semantic interpretation and extracted information; generate, from the structured information, a schedule information object including time information and event information converted into an internal data format; store the schedule information object in a storage device and/or generate notification information based on the schedule information object for transmission to the information processing terminal; optionally cooperate with an external information processing service based on the schedule information object to perform at least one of schedule registration, notification transmission, and resource reservation; and, when the structured information indicates that schedule information is missing or ambiguous, generate an additional prompt sentence requesting clarification, obtain a query sentence from the generative information processing model, transmit the query sentence to the information processing terminal to acquire additional user input, and regenerate the schedule information object based on an updated analysis result including the additional input. This enables a technical improvement in computer-implemented schedule management by providing a server-side processing architecture that reliably transforms noisy natural language input into consistent, structured schedule data through standardized preprocessing, controlled prompt construction, model-based semantic analysis, deterministic schedule object generation, and an integrated clarification loop, thereby enhancing accuracy, robustness, and traceability of automated scheduling operations.

The term “processor” refers to a hardware and/or software computation unit, such as a central processing unit or execution core, that executes instructions to perform functions including receiving data, preprocessing text, generating prompt sentences, communicating with external models, and generating structured schedule information objects.

The term “information processing terminal” refers to an electronic device operated by a user, such as a general-purpose computing device, that provides a user interface for inputting natural language information and for receiving and displaying notification information from a server.

The term “input information expressed in natural language” refers to unstructured or semi-structured linguistic content, including text or text obtained from speech recognition, that is written or spoken in a human language and represents a user's request, schedule, or intent.

The term “preprocess” refers to performing one or more data transformation operations on input information, including removal of unnecessary elements and normalization of character information, to generate analysis text information suitable for subsequent natural language analysis.

The term “unnecessary elements” refers to components of the input information, such as extraneous whitespace, control characters, special symbols, or irrelevant tokens, whose removal or transformation does not change the substantive semantic content relevant to schedule extraction.

The term “character information” refers to digital representations of textual elements, including letters, numbers, symbols, and punctuation marks encoded in a character set, which can be normalized to reduce variation in form while preserving meaning.

The term “analysis text information” refers to a normalized text representation derived from the input information through preprocessing, which is structured and cleaned to facilitate accurate semantic interpretation and information extraction by subsequent processing.

The term “instruction template” refers to a predefined text pattern or schema used to construct a prompt sentence, into which analysis text information and, optionally, example inputs and outputs or other guidance are embedded to control the behavior of a generative information processing model.

The term “prompt sentence” refers to a sequence of characters or tokens, including an instruction template and embedded analysis text information, that is transmitted to a generative information processing model to request semantic interpretation and extraction of relevant information.

The term “generative information processing model” refers to a trained machine learning model, such as a generative artificial intelligence model or large language model, that receives a prompt sentence and generates output representing semantic analysis, extracted entities, or other derived information in response to the prompt sentence.

The term “external information processing apparatus” refers to a computing resource separate from the server, such as a remote computing system or cloud-based service, that executes the generative information processing model and returns output to the server over a communication network.

The term “structured information” refers to data generated by the generative information processing model in a machine-readable format, such as a key-value representation or hierarchical structure, that explicitly encodes extracted items including time information and event information derived from the analysis text information.

The term “semantic interpretation” refers to the process of determining the meaning, intention, and relevant entities contained in the analysis text information, including identification of temporal expressions, event descriptions, and user intent, as represented in the structured information.

The term “schedule information” refers to information that represents a temporal event or task, including at least one of time information, event information, and user-related metadata, which can be registered, managed, and used for scheduling operations.

The term “time information” refers to data representing a temporal element, such as a date, time of day, or time period, which may be normalized to a standard time representation for storage and processing.

The term “event information” refers to data representing the content or description of an occurrence, activity, meeting, appointment, or task that is to be associated with time information in the context of schedule management.

The term “internal data format” refers to a predefined data structure used within the server, such as a record or object schema, in which schedule information is encoded for consistent processing, storage, and integration with other server-side components and services.

The term “schedule information object” refers to an instance of structured schedule information represented in the internal data format, including at least time information, event information, and, optionally, additional attributes such as user identifiers, status, and metadata.

The term “storage device” refers to a hardware and/or software component, such as a memory subsystem or data storage system, configured to store data persistently or semi-persistently, including schedule information objects and related logs.

The term “notification information” refers to data representing a message or indication generated based on a schedule information object, which is intended to inform the user of a created, updated, or upcoming schedule or related action.

The term “external information processing service” refers to a remotely accessible software service, such as a scheduling, messaging, or resource management service, that is configured to receive schedule-related data from the server and perform operations including schedule registration, notification transmission, or resource reservation.

The term “schedule registration” refers to the process of creating or updating an entry representing schedule information within an internal or external scheduling system, calendar system, or equivalent data management system.

The term “notification transmission” refers to the operation of sending notification information from the server or an integrated service to a target endpoint, such as an information processing terminal or communication address associated with the user.

The term “resource reservation” refers to the process of allocating or booking a resource, such as a facility, service slot, or equipment, for a specified time period based on schedule information contained in a schedule information object.

The term “emotional state” refers to an estimated psychological condition of the user, such as satisfaction, frustration, or urgency, inferred from the structured information or related context, which can be used to adjust response content or proposal content.

The term “response content” refers to information generated by the server and transmitted to the user, including explanations, confirmations, or conversational messages, which may be adapted based on the user's emotional state.

The term “proposal content” refers to recommendations, suggestions, or options presented to the user, such as proposed schedule times, alternative events, or actions, which may be selected or phrased based on the estimated emotional state.

The term “additional prompt sentence” refers to a prompt sentence generated after initial processing, which includes instruction content for obtaining clarification or missing information regarding schedule information that is determined to be incomplete or ambiguous.

The term “query sentence” refers to a natural language question or request for clarification generated by the generative information processing model in response to an additional prompt sentence, which is intended to be presented to the user to obtain additional input.

The term “additional input” refers to supplementary natural language information provided by the user in response to a query sentence, which supplies missing or clarifying details necessary for accurate schedule information generation.

The term “updated analysis result” refers to a result of semantic interpretation and information extraction that is obtained by processing both the original input information and the additional input, and that is used to regenerate the schedule information object with reduced ambiguity.

Server executes the invention using a combination of hardware and software components configured to implement the functions recited in the claims. Server includes at least one processor, a memory, a non-volatile storage device, and a network interface. Server executes an operating system such as a general-purpose server operating system, and runs one or more application programs implementing a text preprocessing module, a prompt construction module, a model interaction module, an interpretation and mapping module, and a schedule data management module. Server connects to one or more external information processing apparatuses via a communication network using a standardized protocol such as HTTPS.

Terminal is implemented as a general-purpose computing device including a processor, a memory, a display, an input interface, and a network interface. Terminal executes a client application or web browser that provides a graphical user interface for user. User operates terminal to input natural language utterances representing requests or schedules, and to view notification information transmitted from server. Terminal may utilize a speech recognition component to convert user speech into text; such speech recognition may be provided by an operating system service or a network-based recognition service.

User interacts with terminal by entering natural language text or speech such as “Please book a dentist appointment for 3 p.m. tomorrow” or “I want to have lunch with my friend next Friday.” Terminal transmits the resulting text, together with metadata such as user identification information, timestamp, and locale information, to server. Terminal displays confirmation messages and clarification questions generated by server so that user can verify, correct, or supplement the schedule information handled by the system.

Server, upon receiving natural language input, performs concrete data processing and data computation in a defined pipeline. Server first applies a preprocessing module implemented using text processing libraries such as a regular expression engine and a Unicode normalization library. Server removes unnecessary elements, including repeated whitespace, control characters, and non-semantic symbols, from the input text. Server normalizes character information, for example converting different encodings or width variants of characters into a canonical representation. Server may apply tokenization or segmentation using a language-specific tokenizer to facilitate later semantic analysis. This preprocessing produces analysis text information that is more uniform and less noisy, which directly improves the accuracy and computation efficiency of subsequent processing by reducing the search space of relevant patterns and reducing the probability of parsing errors.

Server then constructs a prompt sentence by embedding the analysis text information into an instruction template stored in memory. Server may select a template based on user language, domain, or requested function. In a representative embodiment, server constructs a prompt sentence such as:
“From the user's utterance, extract: (1) the date and time, (2) the event description, and (3) the intent type (for example, ‘create_schedule’). Output only a structured description in plain text, with labels ‘date_time’, ‘event’, and ‘intent_type’. User utterance: ‘[analysis text information]’.”

Server may also include one or more in-context examples in the prompt sentence to stabilize the behavior of the generative AI model. For example, server may embed the following text:
“Example input: ‘I want to have lunch with my friend next Friday.’
Example output: date_time: next Friday 12:00; event: lunch with my friend; intent_type: create_schedule.”

Server transmits this prompt sentence, along with model parameters such as temperature, maximum output length, and decoding constraints, to an external generative AI model executed on an external information processing apparatus.

Server interacts with the generative AI model via a defined application programming interface. The generative AI model is implemented as a parameterized neural network with a transformer-based architecture including multiple self-attention layers, feed-forward layers, and layer normalization. The model includes an embedding layer that converts each token of the prompt sentence into a dense feature vector, a stack of transformer blocks that compute contextualized representations by applying multi-head self-attention, and an output layer that predicts the next token in a sequence or generates a sequence conditioned on the entire prompt sentence. The model parameters, including weight matrices of the attention and feed-forward layers, are learned in advance by training on large-scale corpora of natural language text using a loss function such as cross-entropy loss. During training, the model iteratively updates its weights using gradient-based optimization and backpropagation, thereby minimizing the discrepancy between predicted tokens and ground truth tokens.

Server does not re-train the generative AI model during normal operation, but server controls how the model is used at inference time by constructing the prompt sentence, setting decoding parameters, and optionally constraining the output format. Server, by embedding explicit labels and examples in the prompt sentence, biases the model to output a predictable structure containing labeled fields such as “date_time,” “event,” and “intent_type.” This control of the generative AI model's behavior is itself a technical mechanism that reduces the need for complex rule-based post-parsing and lowers the error rate in downstream mapping operations.

Server receives generated text from the external information processing apparatus as the output of the generative AI model. Server applies an interpretation and mapping module to this output. This module parses the labeled segments of the generated text according to predefined delimiters and label patterns. Server uses a finite-state parser or deterministic string parsing routines to identify segments following labels such as “date_time:” and “event:”. Server then converts natural language date expressions like “tomorrow,” “next Friday,” or “this afternoon” into absolute time representations by invoking a date-time resolution algorithm. This algorithm uses the current system time of server, user locale, and user time zone to compute a timestamp in a standardized format such as Coordinated Universal Time. Server may use a deterministic set of rules to resolve ambiguous expressions, for example treating “next Friday” as the first Friday occurring after the current week according to a defined calendar convention.

Server creates a schedule information object in an internal data format defined as a record structure containing fields such as user identifier, normalized start time, optional end time or duration, event label, description, and status. Server stores this schedule information object in a storage device, which may be a relational database management system or a document database system. Server writes the data using structured queries or object-relational mapping operations. Server also creates log records linking the original natural language input, the analysis text information, the prompt sentence, the model output, and the final schedule information object. This end-to-end traceability improves debugging and auditing capabilities and permits quantitative evaluation of system performance.

Server generates notification information based on the schedule information object. For example, server constructs a textual confirmation such as “I have added ‘Dentist appointment’ at 3 p.m. tomorrow to your schedule.” Server may also generate structured notification metadata including schedule identifier and alarm settings. Server transmits notification information to terminal for display. Server optionally interacts with an external information processing service, such as a generic calendar service or resource management system, by converting the schedule information object into an external service format and sending it over the network. This interaction enables automatic registration of events and reservations, which are then accessible on other devices and applications.

Server additionally implements an emotional state estimation function according to dependent claim features. Server analyzes structured information returned by the generative AI model to identify sentiment indicators such as expressions of urgency, frustration, or hesitation. Server may use rules or an auxiliary classifier model to map these indicators to an emotional state label. Server then adapts response content or proposal content based on the estimated emotional state. For example, if the user appears uncertain, server may suggest multiple time options rather than confirming a single schedule. This adaptation is implemented by selecting alternative templates for notification information and by modifying parameters of follow-up prompt sentences. The result is more context-appropriate system behavior, which increases user satisfaction and may reduce the number of correction operations.

Server implements an ambiguity resolution mechanism using additional prompt sentences when initial schedule information is incomplete or ambiguous. Server examines the structured information from the generative AI model to determine whether required fields such as time information or event information are missing or conflicting. When server detects such a condition, server constructs an additional prompt sentence, such as:
“The user wrote: ‘Schedule a meeting with John.’ Generate a short, polite question asking the user to specify both date and time. Respond with only that question.”

Server transmits this additional prompt sentence to the generative AI model and receives a query sentence, such as “On what date and at what time would you like to schedule the meeting with John?” Server forwards this query sentence to terminal, and user responds with additional input. Server then repeats the analysis process using both the original and additional input. This iterative clarification loop is integrated into the server's dataflow and is not a mere automation of human questioning, because server uses explicit conditions and formats to generate additional prompts, assuring consistency and machine-traceable handling of ambiguous cases.

Server achieves technical improvements in computer technology through the described architecture. The preprocessing and normalization of input text reduce variability in character encodings and extraneous symbols, which improves cache locality and reduces branching in text handling routines, leading to faster and more predictable performance. The explicit construction of prompt sentences with embedded labels and examples reduces variance in generative AI model outputs, thereby lowering the complexity of the subsequent parsing module and reducing the number of error-handling branches. The deterministic mapping from labeled textual output into a predefined schedule information object reduces ambiguity and simplifies database schema design, which improves both query performance and data consistency.

Server, by offloading semantically complex language understanding tasks to a generative AI model running on an external information processing apparatus, can devote more local processing power to I/O handling, database operations, and real-time notifications. This division of labor is not a simple outsourcing of human reasoning but a specific computational distribution that makes use of different hardware resources optimized for distinct types of computation. Server reduces communication load by transmitting only compact prompt sentences and receiving only necessary structured information, rather than transferring entire context histories or multiple partially processed representations. Server also implements caching of frequently used prompt templates and results to further reduce latency and computational overhead.

Server uses a generative AI model that was trained by minimizing an objective function over large-scale data, using stochastic gradient descent or similar optimization algorithms. During training, the model learns internal feature representations that capture non-obvious correlations between expressions of time and event structures in different linguistic contexts. These learned feature representations enable the model to interpret input utterances in a way that conventional rule-based systems cannot easily replicate. For example, the model can infer that “tomorrow afternoon” in a particular locale implies a time range between defined hours, and can adjust for context such as “after work” when mapping expressions to actual times. The system thus uses a non-conventional, data-driven rule set encoded in the model weights, rather than fixed handcrafted rules, which contributes to improved accuracy and robustness for diverse user inputs.

Server can implement multiple embodiments and variations while remaining within the scope of the claims. In one embodiment, server uses a single generative AI model instance hosted by a cloud service. In another embodiment, server selects between different generative AI models based on language, domain, or user profile. In yet another embodiment, server pre- or post-processes model outputs with additional neural network modules such as a sequence tagging model specialized for temporal expressions. Terminal may be implemented as a mobile application, a desktop application, or a web application, and may perform local preprocessing of speech recognition results before sending them to server. The storage device may be a relational database system, a key-value store, or a distributed file system, with corresponding changes in how schedule information objects are serialized and indexed.

Server may further include security and privacy mechanisms, such as encryption of prompt sentences and structured information at rest and in transit, and access control for schedule information objects based on user identifiers. These mechanisms ensure that the technical improvements in schedule management do not compromise data protection.

By combining structured preprocessing, controlled prompt sentence construction, transformer-based generative AI model inference, deterministic mapping to internal schedule information objects, and an integrated ambiguity resolution loop, server provides a concrete technical solution that improves processing accuracy, reduces computational overhead in interpretation logic, enhances data consistency in storage, and lowers the need for manual corrections. This solution constitutes an improvement in the functioning of computer systems for natural language schedule management, rather than a mere automation of human planning tasks.

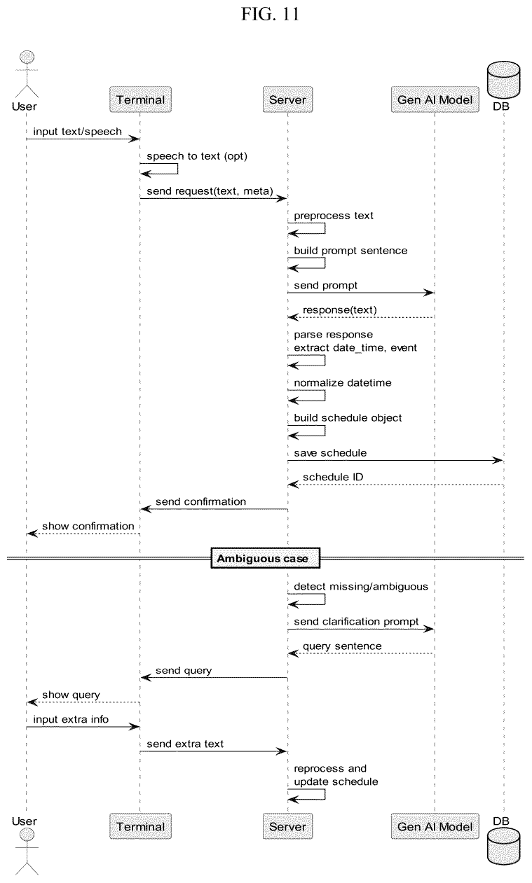

The following describes the processing flow using FIG. 11.

### Step 1:

User operates terminal and starts an application that presents a text input field and, optionally, a microphone button.
User inputs a natural language request or schedule, for example by typing “Please book a dentist appointment for 3 p.m. tomorrow” or speaking the same sentence.
Terminal, when user provides speech, records audio data and converts the audio into text using a speech recognition component.
Input: raw user text or audio data from user.
Output: recognized text string representing the user utterance.
Terminal then packages the text string together with metadata such as user identifier, device identifier, locale, and timestamp into a structured message.
Terminal transmits this structured message to server via a network connection using a protocol such as HTTPS.

### Step 2:

Server receives the structured message from terminal and parses the message to extract the user text and associated metadata fields.
Input: structured message containing user text, user identifier, and metadata from terminal.
Output: raw text string, user identifier, and metadata stored in server memory.
Server records the raw text and metadata in a log store or temporary buffer, assigning a unique request identifier.
Server thereby creates a traceable association between the original user utterance and all subsequent processing steps.

### Step 3:

Server invokes a preprocessing module to clean and normalize the raw text string.
Input: raw text string extracted from the structured message.
Output: analysis text information as a cleaned, normalized text string.
Server removes unnecessary elements such as repeated spaces, control characters, and irrelevant symbols by applying regular expression rules.
Server normalizes character forms, for example by converting mixed encodings or width variants into a canonical character representation.
Server may segment the text into tokens using a tokenizer to handle language-specific boundaries, thereby transforming an unstructured sequence of characters into a more uniform representation suitable for semantic analysis.

### Step 4:

Server constructs a prompt sentence by embedding the analysis text information into a predefined instruction template.
Input: analysis text information and an instruction template stored in server memory.
Output: complete prompt sentence ready to be sent to a generative AI model.
Server selects a template based on factors such as language or task type, then inserts the analysis text information into a designated placeholder of the template.
Server may append one or more example input-output pairs to the prompt sentence to guide model behavior, such as:
“From the user's utterance, extract: (1) the date and time, (2) the event description, and (3) the intent type (for example, ‘create_schedule’). Output only a structured description in plain text with labels ‘date_time’, ‘event’, and ‘intent_type’. User utterance: ‘[analysis text information]’. Example input: ‘I want to have lunch with my friend next Friday.’ Example output: date_time: next Friday 12:00; event: lunch with my friend; intent_type: create_schedule.”

### Step 5:

Server sends the prompt sentence to a generative AI model running on an external information processing apparatus through an application programming interface.
Input: prompt sentence generated by server, along with model configuration parameters such as temperature and maximum output length.
Output: response text generated by the generative AI model.
Server formats the prompt sentence into a request message conforming to the external model API specification and transmits it over HTTPS.
Server waits for the response and, upon receipt, extracts the generated text from the response message and stores it in memory associated with the request identifier.

### Step 6:

Server parses the generated text from the generative AI model to obtain structured information.
Input: generated text returned by the generative AI model.
Output: intermediate structured representation containing fields such as date_time, event, and intent_type.
Server applies deterministic parsing rules, such as searching for label patterns like “date_time:” and “event:”, and splitting the text at delimiters such as line breaks or semicolons.
Server trims whitespace and normalizes any symbols in the parsed segments, thereby converting a free-form model output into a key-value style internal representation.

### Step 7:

Server resolves temporal expressions in the parsed date_time field into a standardized time format.
Input: parsed date_time string (for example, “tomorrow at 3 p.m.”) and metadata including current server time and user time zone.
Output: normalized time value, such as a timestamp or date-time object in a standardized format.
Server uses a date-time interpretation algorithm that maps relative expressions like “tomorrow,” “next Friday,” or “this afternoon” to absolute calendar dates and times using the current date and locale conventions.
Server converts the resulting date and time into a machine-readable representation, such as an ISO-formatted string, to ensure consistency across database operations and integrations.

### Step 8:

Server constructs a schedule information object based on the structured information and normalized time data.
Input: normalized time value, event description string, intent_type label, user identifier, and original analysis text information.
Output: schedule information object containing fields for user, time, event, and optional attributes.
Server populates an internal data structure with the user identifier, a start time field, an event title derived from the event description, a description field containing a more detailed textual representation, and a status field indicating creation state.
Server may apply business rules to adjust or enrich the event data, for example assigning a default duration or checking for basic conflicts with known working hours.

### Step 9:

Server stores the schedule information object in a storage device such as a database.
Input: schedule information object created by server.
Output: persistent record in a schedule table or collection, and a stored schedule identifier.
Server establishes a connection to the storage system and issues an insert operation that writes the schedule fields into defined columns or document keys.
Server receives a unique schedule identifier generated by the storage system, associates it with the schedule information object, and logs the association with the original request identifier to maintain auditability.

### Step 10:

Server generates notification information to confirm the processed schedule to user.
Input: schedule information object including event title and normalized time, and user interface preferences derived from metadata.
Output: confirmation message text and optional metadata for delivery to terminal.
Server formats a human-readable message such as “I have added ‘Dentist appointment’ at 3 p.m. tomorrow to your schedule.” by inserting specific event and time values into a text template.
Server may also include a reference to the schedule identifier and any alert settings in a structured payload that accompanies the confirmation message.

### Step 11:

Server transmits the notification information to terminal over the network.
Input: confirmation message and associated structured payload generated by server.
Output: delivery of the message to terminal and, optionally, to external services.
Server sends the confirmation message as part of an HTTP response or via a push notification service, depending on terminal capabilities and user settings.
Server may additionally transmit schedule data to an external information processing service, converting the internal schedule information object into the external service's event format for registration in an external calendar or reservation system.

### Step 12:

Terminal receives the confirmation message and displays it to user using a graphical user interface.
Input: confirmation message and structured payload from server.
Output: visual presentation of the confirmation on terminal display.
Terminal parses any structured payload to extract displayable elements such as event title and time, then updates its schedule view or notification area.
User reviews the confirmation and, if necessary, may initiate corrections or provide additional input through the same interface, which will be sent to server and processed through the pipeline again.

### Step 13:

Server handles cases where the structured information from the generative AI model indicates missing or ambiguous schedule data.
Input: structured information where a required field such as date_time or event is missing, empty, or marked as uncertain.
Output: additional prompt sentence and subsequent query sentence delivered to terminal for clarification.
Server detects the condition by evaluating the presence and quality of each required field in the structured information.
Server constructs an additional prompt sentence such as: “The user wrote: ‘Schedule a meeting with John.’ Generate a short, polite question asking the user to specify both date and time. Respond with only that question.” and sends it to the generative AI model.
Server receives a query sentence generated by the model, then transmits this query sentence to terminal as a clarification request, enabling user to supply additional input that will be processed as new input information.

### Step 14:

User responds to the clarification query presented on terminal by providing additional natural language input, such as “Next Monday at 10 a.m.”
Input: clarification query displayed by terminal and user's new text or speech response.
Output: supplemental text describing missing schedule details, transmitted to server.
Terminal converts any spoken response into text and packages this supplemental text with references to the original request, then sends it to server.
Server combines the supplemental text with the original analysis text information or processes it as a new utterance, reruns Steps 3 through 10, and regenerates a corrected or completed schedule information object based on the clarified data.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented support systems used in physical stores and other face-to-face environments typically require human operators to manually interpret spoken customer requests, manually input keywords into search interfaces, and manually browse product databases to identify suitable products or services. In such architectures, the computing devices are used primarily as passive information retrieval tools, and the burden of understanding natural language, identifying constraints such as dates, budgets, and events, and formulating concrete proposals rests largely on the human operator. As a result, the overall computing system exhibits latency, inconsistent quality of recommendations, and limited scalability, especially when conversations are complex or evolve over time.

In addition, traditional natural language interfaces that merely convert speech to text and perform keyword matching do not maintain a structured, machine-usable representation of user requirements and schedules across multiple conversational turns. These systems fail to exploit modern generative models in a way that is tightly integrated with structured context, with the consequence that the generated outputs are often generic, poorly grounded in current inventory or business rules, and difficult to present in a concise form suitable for wearable display devices. This leads to inefficient use of processing resources and network bandwidth, because the same or similar user intent must be repeatedly inferred or manually corrected by the operator.

Moreover, existing computing systems generally treat recommendation generation and external system coordination (such as reservation management or task allocation) as separate, loosely coupled functions. As a result, the systems are not configured to automatically propagate the machine-interpreted intent and constraints, as derived from natural language, into downstream operational systems. This lack of end-to-end integration limits the ability of the computer system to autonomously update schedules, manage reservations, or allocate work items, thereby constraining the improvement of overall system throughput and reliability.

There is therefore a need for a computer-implemented system that improves the functioning of the underlying computing components by: (i) automatically transforming streaming spoken dialogue into structured requirement and schedule data; (ii) constructing prompt sentences that drive a generative model to produce context-aware, operation-ready recommendations; (iii) generating presentation information in a format optimized for real-time wearable display; and (iv) automatically coupling the interpreted intent and generated proposals to external management systems. Such a system should reduce the cognitive and operational load on the human operator, decrease end-to-end response time, and enhance the technical performance and utility of the computing platform itself.

The specific processing by the specific processing unit 290 of the data processing device 12 in Application Example 1 is realized by the following means.

The present invention provides a server comprising a processor configured to acquire voice information from a terminal during a dialogue, convert the voice information into text information by using a speech recognition technique, analyze the text information by using a natural language processing technique to extract request information and schedule information and to generate structured information including the request information and the schedule information, generate a prompt sentence based on the structured information to cause a generative artificial intelligence model to generate commodity information or service information to be proposed, obtain response information including the commodity information or the service information from the generative artificial intelligence model and associate the response information with sales target information to generate presentation information, and transmit the presentation information to the terminal for real-time display to support a proposal action by a user. This enables the computing system to automatically transform unstructured spoken dialogue into structured machine-usable context, to drive a generative model with context-rich prompt sentences, and to deliver concise, operation-ready recommendations to a wearable display device with reduced latency and improved utilization of processing and network resources.

The term “voice information” refers to time-varying audio data representing spoken utterances captured by an input device such as a microphone and digitized for processing by a computing apparatus.

The term “dialogue” refers to an interactive exchange comprising one or more utterances between a user and at least one other person, in which information such as requests, preferences, or schedules is communicated.

The term “terminal” refers to an information processing apparatus, such as a wearable device, mobile device, or other client device, that acquires sensor data, communicates with a server, and presents information to a user.

The term “text information” refers to character-based data obtained by converting voice information into a textual representation suitable for natural language analysis and further processing by a computing apparatus.

The term “speech recognition technique” refers to a computational method or algorithm that analyzes voice information and produces corresponding text information, including but not limited to acoustic modeling and language modeling.

The term “natural language processing technique” refers to a computational method or algorithm that analyzes text information to identify linguistic structure, semantic content, or intent, including but not limited to tokenization, syntactic parsing, and entity recognition.

The term “request information” refers to information indicating a need, desire, or requirement expressed in a dialogue, such as a desired product, service, condition, or constraint.

The term “schedule information” refers to information indicating temporal aspects associated with a request, such as dates, times, periods, or deadlines relevant to an event or activity.

The term “structured information” refers to data organized according to a predefined schema, format, or data model, in which elements such as request information and schedule information are represented as explicit fields or attributes usable by other computational components.

The term “prompt sentence” refers to a text sequence provided as input to a generative artificial intelligence model, the text sequence specifying context, constraints, or instructions that guide generation of an output by the model.

The term “generative artificial intelligence model” refers to a computational model that receives an input such as a prompt sentence and generates new data, including but not limited to natural-language text describing products, services, or actions.

The term “commodity information” refers to information describing an item that may be offered or sold, including attributes such as category, characteristics, price range, or availability.

The term “service information” refers to information describing an activity or assistance that may be provided, including attributes such as type, conditions, duration, or scheduling constraints.

The term “response information” refers to output data generated by a generative artificial intelligence model, the output data including commodity information, service information, or explanatory content derived in accordance with a prompt sentence.

The term “sales target information” refers to information related to items or services that are candidates for proposal in a commercial or operational context, including identifiers, inventory status, or location data maintained by a management system.

The term “presentation information” refers to information formatted for display to a user, the information including at least part of the response information and sales target information arranged in a form suitable for real-time consumption.

The term “display device of the terminal” refers to an output component of the terminal, such as a head-mounted display, screen, or other visual interface, that presents presentation information to the user.

The term “proposal action” refers to an act performed by a user to present or recommend a commodity or service to another person, the act being supported or guided by presentation information displayed on the terminal.

The term “emotion information” refers to data indicating an inferred emotional state or attitude, such as satisfaction, frustration, or hesitation, derived from analysis of text information, structured information, or associated contextual signals.

The term “external apparatus” refers to a computing system, device, or service distinct from the server and the terminal, which exchanges data with the server to perform additional processing or control.

The term “schedule management apparatus” refers to an external apparatus configured to store, update, and manage schedule-related data, such as calendar entries, reservation records, or appointment information.

The term “business processing apparatus” refers to an external apparatus configured to execute business-related operations, such as task allocation, workflow control, order processing, or resource management.

The term “reservation information” refers to data representing a booking or reservation for a resource, service, or event, including at least an identification of the resource, a time interval, and participant-related attributes.

The term “task information” refers to data representing a work item or operation to be performed, including attributes such as an assignee, priority, deadline, or associated resource.

In one embodiment, a server cooperates with at least one terminal and at least one user to implement the claimed system. The terminal is, for example, a pair of smart glasses, a handheld mobile device, or a tablet device equipped with a microphone, a display device, a wireless communication interface, a memory, and a processor. The server is, for example, a general-purpose computer or a cloud-based computing instance including one or more central processing units, one or more graphics processing units, a main memory, a non-volatile storage device, and a network interface. The user is, for example, a store clerk wearing the terminal and interacting face-to-face with a customer in a physical facility.

The server executes an operating system such as a UNIX-based system or another multitasking operating system, and executes one or more application programs including a speech processing module, a natural language processing module, a prompt generation module, a generative AI interaction module, a product association module, and a presentation generation module. The server stores program instructions and model parameters in a non-transitory computer-readable medium such as a magnetic disk, a solid-state drive, or a semiconductor memory.

The terminal executes an operating system such as a mobile operating system and runs a communication application configured to capture voice information through the microphone, transmit the voice information to the server via a wireless network, and present presentation information received from the server on the display device. The terminal stores configuration data such as user identifiers and device identifiers in a local memory.

The user wears the terminal, initiates an application on the terminal, and conducts a dialogue with a customer. The terminal captures spoken utterances of the user and the customer as analog audio signals and converts the analog audio signals into digital voice information using an audio codec. The terminal transmits the digital voice information, together with metadata such as timestamps and session identifiers, to the server via a secure communication channel.

The server receives the digital voice information and executes a speech processing module that applies a speech recognition technique. In one embodiment, the server calls a cloud-based speech recognition service that uses acoustic models and language models trained on large-scale speech corpora, such as a deep neural network-based recognizer equivalent to a commercial speech-to-text service. The server configures the recognizer with parameters specifying a sampling rate, a language code, and an automatic punctuation option, and obtains text information that is a sequence of characters corresponding to the spoken utterances.

The server normalizes the text information by converting character encodings, standardizing numerals and date expressions, and removing filler expressions. The server stores the normalized text information in a text buffer in the main memory. The server then executes a natural language processing module implemented, for example, using a library such as spaCy running in a programming language runtime such as Python. The server loads a pre-trained language model that includes a tokenization component, a part-of-speech tagging component, a dependency parsing component, and a named-entity recognition component.

The server applies these components to the text information to generate structured information. The server represents the structured information as, for example, a data record containing fields including an event type, an event date, a product category, a price range, a style preference, and a user intent. The server populates these fields by mapping recognized entities (such as time expressions, event names, product-related terms, and numerical values) to corresponding schema elements. For example, when the customer says, “I have a friend's wedding next Friday and I'm looking for a dress,” the server identifies “wedding” as the event type, “next Friday” as the event date, and “dress” as the product category, and stores these values in the structured information.

The server further executes an intent classification process that uses a statistical classifier or a rule-based engine. In one embodiment, the server uses a logistic regression classifier trained on feature vectors constructed from token n-grams, part-of-speech tags, and dependency patterns to distinguish between intents such as “search”, “compare”, “refine constraints”, and “confirm selection.” The server stores the inferred intent as a field in the structured information. This structured representation enables the server to reuse the same underlying dialogue context across multiple conversational turns without re-parsing the entire dialogue from scratch.

The server then executes a prompt generation module that creates a prompt sentence for a generative AI model. The server inserts values from the structured information into a natural language template that defines a role, a context, a task, and constraints. For example, the server may generate a prompt sentence such as:
“You are an AI sales assistant in a physical fashion store. A customer has told a store clerk that they will attend a friend's wedding next Friday and are looking for a women's dress around 20,000 yen. Based on this situation, propose 3 to 5 suitable dress styles, including color, length, and material, and provide a brief explanation for each style so that the clerk can present them to the customer.”

The server constructs this prompt sentence in memory as a string data structure. The server may add additional constraints, such as limiting the length of the response, specifying a desired tone, or indicating product categories that are not available in the store. Because the prompt sentence is derived from the structured information, the generative AI model receives explicit, machine-generated context that accurately reflects the dialogue state, thereby reducing ambiguity and improving the relevance of generated results.

The server then interacts with a generative AI model. In one embodiment, the server accesses a transformer-based language model equivalent to a commercially available generative model such as a GPT-series model. The generative AI model includes an encoder-decoder or decoder-only neural network architecture, with multiple transformer layers each having multi-head self-attention units, feedforward networks, layer normalization units, and residual connections. The model parameters, including weight matrices and bias vectors, have been pre-trained on a large corpus of text using an unsupervised learning objective such as minimizing a cross-entropy loss between predicted tokens and actual next tokens.

The server sends the prompt sentence to the generative AI model via an application programming interface over a secure network connection. The server sets generation parameters, such as a temperature value controlling sampling randomness, a maximum number of output tokens, and a penalty term to prevent repetitive outputs. The generative AI model processes the prompt sentence by encoding tokens into vector embeddings, passing the embeddings through the transformer layers, and iteratively decoding a sequence of output tokens according to a probability distribution at each time step.

The server receives response information as a sequence of text tokens from the generative AI model. The response information typically includes a list of recommended product or service descriptions and explanatory sentences. The server parses the response information by splitting lines or identifying numbering patterns, and maps portions of the response to candidate product attributes such as color, length, material, and style. The server then executes a product association module that associates these attributes with actual sales target information stored in a local or remote product database.

The server maintains a product database in a relational database management system, for example, one equivalent to a commercially available open-source relational database. The product database stores records for items such as dresses, each record including fields such as a product identifier, category, size, color, price, stock quantity, and store location code. The server executes database queries that apply filters derived from the response information, such as “category=dress”, “price between 15000 and 25000”, and “color in [navy, black, beige]”. The server then retrieves matching records and computes a match score for each record based on the similarity between attributes described in the response information and attributes stored in the database.

The server computes the match score, for example, by representing the response attributes and product attributes as vectors in a feature space and calculating a cosine similarity or a weighted sum of attribute matches. The server uses this score to rank candidate items, thereby selecting a subset of items that are most consistent with the generative AI output and the structured information. This ranking process improves the precision of the final recommendations and ensures that proposals correspond to items actually available in the inventory.

The server then executes a presentation generation module to produce presentation information optimized for the terminal. The server generates a compact representation that includes, for each recommended item, a product name, a price, a main attribute summary (for example, “long navy chiffon dress, suitable for a formal wedding”), and a short phrase that the user can speak to the customer. The server encodes this information in a structured layout specification such as a lightweight markup or a structured text format recognized by the terminal application.

The server transmits the presentation information to the terminal via the network interface. The terminal receives the presentation information, parses the layout specification, and renders the information on the display device. When the terminal is a pair of smart glasses, the terminal overlays text in the user's field of view so that item names, prices, and key selling points appear near the user's line of sight without obstructing the view of the customer or the physical environment. The user reads the displayed information while maintaining natural eye contact and uses the displayed sentences to explain the recommendations to the customer.

The server may further analyze emotion information derived from the text information or from acoustic features of the voice information. In one embodiment, the server computes prosodic features such as pitch, intensity, and speech rate, and combines them with lexical features to infer an emotional state using a classifier such as a multilayer perceptron trained on labeled emotional speech data. The server adjusts the prompt sentence or the presentation information based on the inferred emotion, for example, by instructing the generative AI model to adopt a more reassuring tone if the customer appears hesitant, or by suggesting more affordable options if frustration is detected. This adaptation allows the computing system to provide technically improved interaction strategies that are not achievable by simple rule-based keyword matching.

The server can also perform information cooperation with external apparatuses such as schedule management systems or business processing systems. For example, when the structured information indicates that the customer wishes to reserve a fitting appointment, the server generates a prompt sentence instructing the generative AI model to propose concrete reservation time slots based on current schedule constraints. The server then updates the reservation information in the external schedule management apparatus through an application programming interface, and reflects the confirmed reservation back in the presentation information shown to the user.

The system improves computer technology itself in several ways. First, by representing user requirements and schedule constraints as structured information and using that structured information to generate context-rich prompt sentences, the server reduces the number of tokens required in each prompt, which reduces network traffic between the server and the generative AI model and decreases inference latency. Second, by reusing the structured information across multiple conversational turns, the server avoids redundant parsing and classification, thereby lowering computational load on the natural language processing module. Third, by aligning the generative AI output with an internal product database and ranking items using a similarity score, the server reduces error rates in recommendations and prevents suggestions for unavailable products, which improves the reliability and determinism of the overall computing system.

Additionally, the server uses non-conventional data flows and rule sets. Instead of directly showing raw generative AI outputs to the user, the server applies rule-based post-processing that enforces constraints such as maximum text length for the display, mandatory inclusion of price and location fields, and exclusion of certain product categories. These constraints are encoded as machine-readable rules that are applied algorithmically, leading to consistent formatting and reduced cognitive load on the user. This processing is distinct from human manual editing of responses and represents a specific, computer-implemented adaptation layer that tailors model outputs to the characteristics of wearable display hardware.

In another embodiment, the server uses a fine-tuned generative AI model that has been trained on domain-specific data such as historical recommendation logs and product descriptions. The server trains the model using supervised learning with a loss function that penalizes discrepancies between generated recommendations and expert-curated recommendations. The server updates model parameters by applying an optimization algorithm such as stochastic gradient descent with adaptive learning rates, and may perform data augmentation by paraphrasing historical utterances or by generating synthetic combinations of constraints. This training procedure yields a model that produces more precise and inventory-aware recommendations, thereby improving the technical performance of the system without relying solely on generic language modeling capabilities.

The server can be configured in alternative ways. In one variation, the speech recognition technique is executed entirely on the terminal, and the terminal sends the resulting text information to the server. In another variation, the natural language processing module is partitioned between the terminal and the server so that shallow parsing and entity recognition are executed locally, while deeper context modeling is executed on the server. These configurations allow the system to adapt to network conditions and hardware capabilities, and can reduce communication load by transmitting only intermediate structured information instead of raw audio data.

The terminal may also present multimodal presentation information. For example, the terminal may highlight certain recommendations using different font colors or icons based on match scores computed by the server, or may show arrows or positional cues indicating where recommended items are located in the physical space. Such features provide direct control and guidance to the user in navigating the physical environment, which is a tangible technical application that extends beyond abstract information display.

Because the server integrates streaming speech recognition, structured natural language analysis, generative AI interaction, database matching, and wearable display optimization into a unified data flow, the system operates as a technically improved computing platform.

The server reduces end-to-end latency in recommendation generation, increases accuracy and context relevance by using structured information and ranking algorithms, and decreases unnecessary network traffic through compact prompt sentence design and context reuse.

These improvements arise from specific algorithmic structures and data representations, rather than from mere automation of human mental steps, and therefore constitute an enhancement to the functioning of the computer system itself.

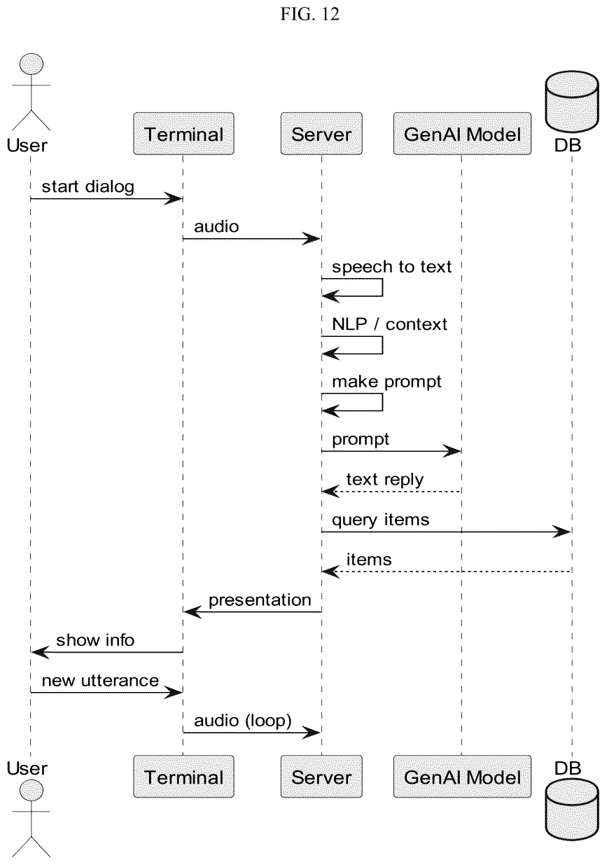

The following describes the processing flow using FIG. 12.

### Step 1:

The user activates an application on the terminal and starts a dialogue with a customer.
The terminal receives analog audio as input from a microphone when the user and the customer speak. The terminal converts the analog audio into digital voice information by sampling and quantizing the signal (for example, 16 kHz, 16-bit mono) and stores short audio frames in a buffer. The terminal attaches metadata such as a session identifier, a timestamp, and a language code to each buffered segment and outputs packetized voice information ready for transmission.

### Step 2:

The terminal transmits the packetized voice information to the server over a secure network connection.
The input to this step is the buffered voice information with metadata. The terminal performs data segmentation and framing, encapsulates each audio segment in a network message (for example, over HTTPS or WebSocket), and applies encryption according to a security protocol. The output of this step is an ordered stream of encrypted voice packets addressed to the server.

### Step 3:

The server receives the encrypted voice packets from the terminal and reconstructs the voice stream.
The input is the stream of network packets containing the audio segments. The server authenticates the terminal using identifiers and tokens, decrypts the packets, and reassembles the audio segments in temporal order based on timestamps. The server outputs a continuous digital voice stream or a sequence of audio chunks suitable for speech recognition.

### Step 4:

The server converts the voice stream into text information using a speech recognition technique.
The input to this step is the digital voice stream or audio chunks. The server feeds the audio to an acoustic-linguistic model (for example, a deep neural network-based recognizer equivalent to a commercial speech-to-text service), which computes acoustic feature vectors, applies neural network inference, and decodes the most probable word sequence using a language model. The output is raw text information representing the recognized utterances.

### Step 5:

The server normalizes the text information and prepares it for natural language processing.
The input is the raw text information from the recognizer. The server applies text normalization operations including character set conversion, removal of filler words, unification of numeral formats, and normalization of date expressions (for example, converting “next Friday” into a canonical internal date representation). The output is normalized text information stored in a text buffer.

### Step 6:

The server analyzes the normalized text information using a natural language processing technique and generates structured information.
The input is the normalized text information. The server invokes a language processing library and executes tokenization, part-of-speech tagging, dependency parsing, and named-entity recognition, computing linguistic features for each token. The server then extracts entities and relations corresponding to request information and schedule information and populates a predetermined schema (for example, event type, date, product category, budget, style preference). The output is structured information represented as a record or object with explicit fields.

### Step 7:

The server determines an intent of the customer and refines the structured information.
The input is the structured information and associated linguistic features. The server computes feature vectors (for example, n-gram features, dependency patterns, and keyword indicators) and feeds them to an intent classifier or rule engine. The server decides whether the utterance corresponds to a search, a refinement, a comparison, or a confirmation, and writes an intent label into the structured information. The output is updated structured information including at least one intent field.

### Step 8:

The server maintains a dialogue context by integrating new structured information with prior context.
The input is the updated structured information for the current utterance and previously stored context information for the same session. The server merges or overwrites fields according to non-conventional rules (for example, new budget values replace old ones, while multiple style preferences are aggregated). The server thus performs data combination and conflict resolution to create a current dialogue context. The output is context-augmented structured information that summarizes constraints and preferences across multiple turns.

### Step 9:

The server generates a prompt sentence for a generative AI model based on the context-augmented structured information.
The input is the context-augmented structured information. The server selects a template and inserts values (such as event, date, product category, and budget) into designated positions, concatenating text fragments into a coherent instruction. The server may add role specification and output requirements (for example, number of recommendations and explanation length). The output is a prompt sentence represented as a text string.

### Step 10:

The server transmits the prompt sentence to a generative AI model and requests generation of recommendation text.
The input is the prompt sentence and generation parameters (for example, temperature and maximum tokens). The server creates a request message, serializes the prompt and parameters, and sends them to a generative AI model endpoint via a network interface. The output of this step is a submitted generation request awaiting response.

### Step 11:

The server receives response information from the generative AI model and parses the generated recommendation text.
The input is a response object containing a sequence of generated tokens from the generative AI model. The server extracts the text field, performs segmentation into individual recommendations (for example, by splitting at line breaks or numbering markers), and identifies textual segments corresponding to product or service attributes and explanatory phrases. The output is parsed response information comprising a list or array of recommendation elements.

### Step 12:

The server extracts candidate attributes from the parsed response information and prepares them for database matching.
The input is the parsed response information. The server applies pattern matching and keyword extraction to identify attributes such as product category, color, length, material, and price range from each recommendation element. The server maps these text attributes to internal attribute codes and creates attribute vectors. The output is a set of structured candidate attributes linked to each recommendation element.

### Step 13:

The server retrieves sales target information from a product database based on the candidate attributes.
The input is the set of candidate attributes. The server composes database queries using attribute filters and executes them against a product database that stores item records. The server receives query results and loads corresponding product records into memory. The output is a collection of sales target information records that satisfy the candidate attribute constraints.

### Step 14:

The server computes match scores between the candidate attributes and the sales target information.
The input is the collection of candidate attributes and the collection of product records. The server converts both into feature vectors (for example, binary or weighted encodings for category, color, length, and price range) and computes similarity measures such as cosine similarity or weighted sums. The server assigns a numerical match score to each product record for each recommendation element and sorts the products by score. The output is ranked sales target information associated with the recommendations.

### Step 15:

The server generates presentation information by combining the ranked sales target information with the parsed response information.
The input is the ranked sales target information and the parsed response information. The server selects top-ranked products, extracts essential attributes (name, price, key features, and store location), and combines them with explanatory phrases from the generative AI output.
The server formats this combined data into a layout specification that is constrained by display capacity (for example, maximum lines and characters). The output is presentation information formatted for the terminal.

### Step 16:

The server optionally adjusts the presentation information based on emotion information or interaction context.
The input is preliminary presentation information and emotion information derived from previous analysis (for example, sentiment or prosodic indicators). The server applies rule-based transformations to modify tone phrases, select more conservative or more luxurious options, or adjust the number of recommendations shown. The output is context-refined presentation information that better matches the inferred state of the customer.

### Step 17:

The server transmits the presentation information to the terminal for real-time display.
The input is the final presentation information. The server serializes the layout specification, encapsulates it in a network message, and sends it to the terminal over the existing session.
The output is a delivered presentation payload waiting to be rendered on the terminal.

### Step 18:

The terminal receives the presentation information and renders it on the display device.
The input is the serialized presentation payload from the server. The terminal parses the layout specification, allocates regions on the display, and generates visual elements such as text lines and icons. The terminal applies rendering rules to ensure legibility and minimal obstruction of the user's field of view. The output is a visual presentation of recommendations visible to the user.

### Step 19:

The user views the displayed recommendations and performs a proposal action toward the customer.
The input is the visual presentation on the terminal display. The user reads the suggested items, prices, and explanatory phrases, and uses this information to verbally propose products or services and to guide the customer to the corresponding physical locations. The output is an informed interaction in which the user's spoken proposal is directly supported by the computed and displayed recommendations.

### Step 20:

The terminal continues to capture subsequent utterances and triggers iterative updates of the recommendations.
The input is new voice information resulting from follow-up questions or constraint changes (for example, a request for cheaper or shorter items). The terminal repeats capture and transmission, and the server repeats recognition, analysis, prompt sentence generation, and recommendation generation. The output is updated presentation information that reflects the evolving requirements and is repeatedly supplied to the user in near real time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computerized scheduling and task-management systems typically rely on rigid rule engines or simple intent classifiers to interpret user requests and operate external information management services. Such systems often treat natural language input, user context, and external service responses as loosely coupled elements, processed in a linear and brittle pipeline. As a result, these systems suffer from at least the following technical problems.

First, conventional systems exhibit low robustness and accuracy when handling ambiguous, multi-constraint natural language requests, such as requests that implicitly encode time preferences, priorities, or conflicts with existing schedules. Because these systems do not tightly integrate rich state information, such as user behavior history and temporal preferences, into the core decision process, they frequently generate suboptimal or conflicting operations on external services, thereby requiring repeated manual corrections by the user.

Second, in many existing architectures, a generative AI model, if used at all, is invoked in an ad-hoc manner with unstructured prompts that do not systematically represent the internal system state or scheduling constraints. This leads to non-deterministic or inconsistent outputs from the generative AI model. Furthermore, such outputs are often applied directly to external systems without machine-verifiable validation or reconciliation with independently computed action candidates. This lack of a structured feedback and verification loop yields unreliable system behavior and increases the likelihood of schedule collisions or invalid operations.

Third, conventional systems typically do not record, in a unified and machine-processable form, the end-to-end processing artifacts such as input text, contextual state information, prompt content, generative AI output, and finally executed actions. Without such structured logging and reuse as learning data, the system cannot systematically improve its models or its prompt generation logic over time. This constrains the system's ability to adapt to evolving user patterns and degrades long-term performance and efficiency.

Fourth, existing systems generally do not provide a concrete mechanism for automatically combining the outputs of a generative AI model with outputs of deterministic or discriminative models (for example, supervised machine learning models or rule-based engines), nor do they provide a clear arbitration mechanism in case of discrepancy.

Consequently, the overall system cannot guarantee that final actions satisfy both learned user preferences and explicit scheduling constraints while remaining consistent with the external information management environment.

Accordingly, there is a need for an improved computer-implemented scheduling and information management system that (i) acquires and maintains structured state information about users and their environments, (ii) generates prompt sentences in a systematic and state-aware manner to drive a generative AI model, (iii) validates and reconciles generative AI outputs with independent machine learning or rule-based action candidates, and (iv) records all intermediate artifacts as learning data for continuous model and prompt optimization. Such a system would improve the technical functioning of the computer architecture itself by enhancing reliability, consistency, and efficiency in automated interaction with external information processing apparatuses.

The specific processing by the specific processing unit 290 of the data processing device 12 in Example 2 is realized by the following means.

The present invention provides a server comprising a processor configured to acquire natural language input including a request or schedule from a terminal, generate text data representing the request or schedule, analyze the text data by natural language processing to extract structured elements including request content, schedule content, date and time information, and constraint conditions, obtain state information including at least user history information and environment information, determine candidate actions by using the state information and the extracted elements, generate a structured prompt sentence that embeds the state information and the candidate actions for input to a generative AI model, execute an inference process by the generative AI model using the prompt sentence to obtain response data specifying at least part of the candidate actions as concrete operation procedures or operation parameters, verify the response data against predetermined determination conditions and independently determined action candidates from a machine learning model or rule-based logic to determine a final action, transmit operation information corresponding to the final action to an external information processing apparatus so as to register or update reservation information or schedule information by using an information management function or schedule management function of the external information processing apparatus, generate a response message to the user based on processing result information returned from the external information processing apparatus, and record the text data, the state information, the prompt sentence, the response data, and the final action as learning data for updating at least one of the machine learning model and a prompt sentence generation process for the generative AI model. This enables technical improvement of computer-implemented scheduling and information management by tightly integrating structured state information with generative AI inference, implementing a verification and arbitration mechanism between generative outputs and deterministic action candidates, and establishing a feedback loop that uses end-to-end processing artifacts as learning data, thereby enhancing the reliability, accuracy, and adaptability of automated operations on external information processing apparatuses.

The term “processor” refers to one or more hardware processing units, such as a central processing unit or other computation circuitry, configured to execute instructions to perform the functions described in the present specification and claims.

The term “terminal” refers to an information processing device operated by a user, including but not limited to a mobile device, a portable device, or a stationary device, that provides a user interface for inputting natural language and receiving responses.

The term “user” refers to a human operator who interacts with the terminal and the system by providing requests or schedules and receiving response messages.

The term “natural language input” refers to information expressed in a human language, in text or speech converted to text, that includes at least a request, a schedule, or related instructions provided by the user.

The term “text data” refers to a data structure representing the natural language input in a textual form, which may include characters, tokens, or encoded representations suitable for computational processing.

The term “request” refers to a user instruction expressed in natural language that asks the system to perform an operation, such as scheduling, rescheduling, cancelling, or querying information.

The term “schedule” refers to information indicating one or more events or activities associated with time, date, or period, including planned reservations, appointments, or tasks.

The term “natural language processing” refers to computational techniques for analyzing text data, including but not limited to tokenization, part-of-speech tagging, entity extraction, intent detection, and semantic parsing.

The term “request content” refers to structured information representing what operation the user is asking the system to perform, derived from the natural language input by natural language processing.

The term “schedule content” refers to structured information representing the type of event, subject matter, or activity to be scheduled or modified, derived from the natural language input by natural language processing.

The term “date and time information” refers to structured temporal data, including dates, times, durations, and periods, derived from explicit or implicit expressions in the natural language input.

The term “constraint conditions” refers to restrictions or preferences that limit or shape the possible actions or schedules, including time windows, priorities, required durations, or exclusion conditions inferred or extracted from the natural language input or state information.

The term “state information” refers to contextual data associated with the user and the environment, including but not limited to user history information, environment information, temporal preference information, behavior history information, service usage history information, and free-time schedule information.

The term “user history information” refers to information indicating past interactions or operations associated with the user, including previously scheduled events, confirmed actions, and historical corrections or overrides.

The term “environment information” refers to contextual information about the operating environment of the system, including but not limited to time zone, locale settings, device characteristics, and external service configuration.

The term “temporal preference information” refers to information indicating user-specific preferences related to time, such as preferred working hours, preferred appointment times, and habitual time ranges for certain types of events.

The term “behavior history information” refers to data indicating patterns of user behavior over time, such as typical rescheduling behavior, cancellation patterns, or response latency to reminders.

The term “service usage history information” refers to information indicating how the user has previously used external information services, including frequency and type of requested operations and preferred external resources.

The term “free-time schedule information” refers to time periods during which the user is determined or inferred to have no conflicting events or obligations, computed from existing schedule information and state information.

The term “candidate actions” refers to one or more possible operations that the system may perform in response to a user request, such as creating, updating, moving, or deleting events in a schedule.

The term “prompt sentence” refers to a text or text-like data structure that encodes at least part of the text data, state information, and candidate actions in a form suitable for input to a generative AI model.

The term “generative AI model” refers to a machine learning model that generates output data, including natural language or structured data, in response to an input prompt sentence, based on parameters learned from training data.

The term “inference process” refers to a computational process in which a trained model, including a generative AI model or another machine learning model, receives input data and produces output data without further training.

The term “response data” refers to output data produced by the generative AI model in response to the prompt sentence, the output data including proposed actions, operation procedures, or operation parameters.

The term “operation procedures” refers to descriptions or sequences of steps that specify how to perform a particular action on an external information processing apparatus or within the system.

The term “operation parameters” refers to structured values specifying details of an operation, such as event title, start time, end time, duration, location, and other attributes required to execute the operation.

The term “verification” refers to a process of checking the response data against predetermined determination conditions, system constraints, and independently computed candidates, in order to detect inconsistencies, errors, or violations.

The term “predetermined determination conditions” refers to rules, thresholds, or criteria defined in advance, used to evaluate whether response data or candidate actions are acceptable, safe, or optimal.

The term “machine learning model” refers to a computational model trained using data examples to map inputs to outputs, including but not limited to classification models, regression models, ranking models, and policy models.

The term “rule-based determination” refers to a decision process that applies explicit logical or arithmetic rules, specified by configuration or code, to derive or filter action candidates independently of trainable model parameters.

The term “final action” refers to a single action or a set of actions selected by the system, after verification and arbitration, to be executed on an external information processing apparatus in response to a user request.

The term “operation information” refers to data specifying the final action in a form suitable for transmission to and execution by an external information processing apparatus, including operation procedures and operation parameters.

The term “external information processing apparatus” refers to a computerized system or service, separate from the server of the present invention, that provides an information management function, a schedule management function, or similar functionality.

The term “information management function” refers to a capability of an external information processing apparatus to store, retrieve, and modify information items, such as records, documents, or data objects.

The term “schedule management function” refers to a capability of an external information processing apparatus to create, modify, retrieve, and delete schedule information, such as calendar events, tasks, or appointments.

The term “reservation information” refers to schedule information that reserves a resource or time slot with an external provider, including but not limited to appointments, bookings, or registrations.

The term “schedule information” refers to information representing planned events or tasks associated with date and time, maintained by an external information processing apparatus or the system.

The term “processing result information” refers to information returned from an external information processing apparatus indicating the outcome of executing operation information, including success, failure, and resulting data such as event identifiers.

The term “response message” refers to information generated by the server and provided to the user via the terminal, summarizing at least the processing result information and the effect of the final action.

The term “learning data” refers to stored data that includes at least text data, state information, prompt sentences, response data, and final actions, and that is used to train, fine-tune, or adjust models or prompt sentence generation processes.

The term “prompt sentence generation process” refers to a set of procedures, templates, or algorithms used to construct prompt sentences for the generative AI model based on text data, state information, and candidate actions.

The term “existing schedule information” refers to schedule entries already registered in an external information management function or schedule management function before processing a current user request.

The term “time overlap” refers to a condition in which time periods associated with two or more schedules intersect, overlap, or conflict partially or wholly.

The term “priority rules” refers to rules that define relative importance among different events, event types, or users'preferences, and that are used to resolve conflicts and select among overlapping schedules.

The term “new registration” refers to an operation that creates a new schedule entry or reservation that did not exist prior to the current processing.

The term “modification” refers to an operation that changes attributes of an existing schedule entry or reservation, including but not limited to time, duration, title, or location.

The term “deletion” refers to an operation that removes an existing schedule entry or reservation from the external information management function or schedule management function.

In one embodiment, a server cooperates with a terminal operated by a user to realize the claimed system. The server includes at least one hardware processor, a main memory, a non-volatile storage device, a network interface, and an interface to one or more external information processing apparatuses such as calendar management systems or reservation management systems. The terminal includes at least a processor, a display, a user input device such as a touchscreen or keyboard, a memory, and a network communication module.

The terminal provides a user interface allowing the user to input natural language text expressing a request or a schedule. The terminal displays an input field and transmits the text data entered by the user to the server via a network, using a communication protocol such as HTTPS over a packet-switched network. The terminal transfers the data in a structured message format, such as a JSON or similar textual representation, but the actual prompt sentences for a generative AI model remain as plain text strings within the server.

The server stores executable instructions in the non-volatile storage device. When the server loads these instructions into main memory, the processor executes them to implement the functional modules described below. In one embodiment, the server uses a general-purpose operating system, an application runtime environment such as a virtual machine or an interpreter, and frameworks for network communication and data persistence. The server additionally accesses external natural language processing services and generative AI services via APIs, using generic HTTP client libraries.

The server acquires natural language input from the terminal and generates internal text data for further processing. The server treats the received user input as a sequence of characters and stores it in a request data structure that includes at least a user identifier, a timestamp, a language code, and original text content. The server uses a text normalization module implemented by the processor to perform operations such as Unicode normalization, lowercasing, and removal of extraneous control characters, so as to reduce noise in subsequent language analysis. This text normalization results in improved accuracy and reduced error propagation in downstream modules, thereby enhancing the overall computational efficiency.

The server performs natural language processing on the text data to extract request content, schedule content, date and time information, and constraint conditions. In one embodiment, the server uses a combination of local models and external natural language processing engines. The server uses a tokenization component to segment the text into tokens, and uses a part-of-speech tagger and a named entity recognizer implemented as statistical or neural models. For example, the server may use a bidirectional recurrent neural network with long short-term memory units or a transformer-based encoder to assign labels to tokens and to detect semantic roles.

The server uses feature vectors derived from token embeddings, positional encodings, and character-level representations as input to these models. The server stores model parameters as multi-dimensional floating-point arrays in the non-volatile storage device, and loads them into memory during inference. The server updates these parameters during offline training by applying supervised learning procedures, such as mini-batch gradient descent, with a loss function such as cross-entropy loss for classification or sequence labeling tasks. During inference, the server computes forward passes through the neural network without modifying the parameters, thereby generating predicted labels and entity boundaries.

The server converts the predicted labels into structured data representing request content (for example, “create event,” “reschedule event,” “cancel event”), schedule content (for example, “dentist appointment,” “meeting,” “lunch”), date and time expressions (for example, “next Tuesday,” “tomorrow afternoon,” specific times), and constraint conditions (for example, “two hours free,” “in the morning,” “after 3 pm”). The server uses a date and time resolution module to transform vague expressions into concrete timestamps using the user's time zone and locale. This module uses algorithms for relative date computation that consider the current date, the week boundaries, and locale-specific weekend settings, thereby improving the technical precision of time resolution compared to manual interpretation.

The server obtains state information that extends beyond a single request in order to improve the quality of automatic decision-making. The server retrieves, from a database stored on the non-volatile storage device, user history information, environment information, temporal preference information, behavior history information, service usage history information, and free-time schedule information. The server stores these data as normalized relational records or as documents in a structured format. For example, the server may store temporal preference information as vectors indicating typical time ranges for different event categories.

The server periodically updates these vectors by analyzing aggregated historical actions using statistical models or clustering algorithms.

The server determines candidate actions by combining the extracted structured elements with the state information. In one embodiment, the server uses a machine learning model distinct from the generative AI model, such as a gradient-boosted decision tree model or a feed-forward neural network classifier, to decide an action type for each request. The server uses features such as request intent, schedule content category, inferred urgency, user temporal preference vectors, conflict counts with existing schedules, and historical success rates of similar actions. The server computes a confidence score for each candidate action.

The server also applies rule-based logic, for example, explicit constraints that disallow overlapping events above a certain overlap duration or that prioritize work events over leisure events during working hours.

The server generates a prompt sentence for input to a generative AI model. The server constructs the prompt as a structured text string that includes natural language description of the user request, summary of extracted entities, and a representation of the state information.

In one embodiment, the server embeds state information in a human-readable but machine-interpretable form, such as labeled lists or structured bullet points. The server uses prompt templates stored in configuration data structures, and fills placeholders with values computed at runtime. This structured, state-aware prompt generation approach improves reproducibility and reduces variance in generative AI outputs compared to ad-hoc prompts, thereby technically enhancing the reliability of the computer-implemented decision process.

In one example, the server generates a prompt sentence such as:
“System: You are a scheduling assistant that must strictly respect user time constraints and existing events.
User request: ‘I want to book a dentist appointment next Tuesday.’
Extracted intent: create event
Extracted subject: dentist appointment
User time zone: UTC+9
User preferred appointment time: 9:00-12:00 on weekdays
Existing events next Tuesday:
   09:00-09:30 team meeting
   13:00-14:00 project review
Goal: Propose one suitable time slot of 30 minutes for the dentist appointment without overlapping existing events and following the user's preferred time range.
Output: Describe the action as: create event with title, start time, end time, and short justification.”

In another example, the server generates a prompt sentence such as:
“Decide the optimal calendar operations based on the user's request and current schedule. User request: ‘Please rearrange my meetings tomorrow so I have two hours free in the afternoon.’
Current schedule tomorrow (local time): multiple 30-minute and 60-minute meetings from 09:00 to 17:00.
Constraints:
   Preserve at least one meeting with each participant.
   Free a continuous two-hour block between 13:00 and 17:00.
   Minimize the number of moved meetings.
Output: Explain which events to move, to what times, and why.”

The server sends such prompt sentences to a generative AI model hosted either on the same server or on an external computing resource. In one embodiment, the generative AI model is a transformer-based neural network with multiple encoder-decoder layers, multi-head self-attention mechanisms, and feed-forward sublayers. The server stores model weights as matrices of floating-point values and performs dense matrix multiplications and non-linear activations during inference. The server uses position embeddings to retain ordering information in the prompt sentence tokens. The server may use a beam search algorithm to generate the output sequence, thereby balancing exploration of alternative token sequences and computational cost. The server sets generation parameters such as temperature, top-k or top-p sampling thresholds, and maximum output length.

The server executes an inference process by the generative AI model to obtain response data that describes candidate actions as concrete operation procedures or operation parameters.

For example, the response data may specify: “Create an event titled ‘Dentist appointment’ on next Tuesday from 10:00 to 10:30 local time,” or “Move the meeting with A from 14:00-15:00 to 16:00-17:00 and free 14:00-16:00.” The server receives the output text and parses it using deterministic parsing rules or lightweight natural language parsers, mapping phrases to structured fields such as event title, start time, end time, and list of affected existing events.

The server verifies the response data using predetermined determination conditions and by comparing with independently computed candidate actions. The server evaluates constraints such as absence of time overlap beyond allowed thresholds, consistency with user temporal preferences, and adherence to hard rules like not scheduling events outside defined working hours. The server uses algorithms that compute intersection intervals between the proposed event time ranges and existing schedule time ranges, and measures time overlap in units of minutes. The server calculates violation scores based on the amount of overlap and the priorities assigned to existing events. The server rejects or modifies any action that exceeds a violation threshold. By implementing such verification and arbitration, the server reduces the rate of invalid or conflicting operations, thereby providing a technical improvement in terms of error reduction and increased robustness of automated scheduling.

The server determines a final action by selecting at least one candidate that satisfies the verification conditions and that optimizes an objective function, such as minimizing schedule disruption, maximizing adherence to user preferences, or minimizing the number of external API calls. The server may combine the confidence scores from the machine learning model with evaluation scores from the verification module to compute an overall utility value. The server selects the action with the highest utility that satisfies all hard constraints as the final action.

The server prepares operation information corresponding to the final action and transmits it to an external information processing apparatus. The server generates a request to an external calendar or reservation system in a structured protocol format expected by that system. The server uses network interface hardware and a communication stack to perform secure transmission. The server includes parameters such as event title, start and end times, location, reminders, and identifiers for existing events requiring modification or deletion. The server manages authentication with the external system using an authorization protocol and maintains access tokens in a secure storage area.

The server receives processing result information from the external information processing apparatus. This processing result information may contain identifiers assigned to newly created events, confirmation of modified or deleted events, and error codes in case of failure.

The server stores these identifiers and statuses in the non-volatile storage device as part of the user's schedule information. The server updates free-time schedule information based on the new event layout by recomputing gaps between events using interval algorithms.

The server generates a response message to the user based on the processing result information. The server converts internal structured data to human-readable text that concisely describes what actions have been taken. The server also resolves local date and time formatting and language localization according to the user's environment information.

The server then transmits the response message to the terminal, where the terminal displays the message on the screen. This interaction provides the user with immediate feedback about automatic schedule operations in a form that can be easily understood and verified.

The server records text data, state information, prompt sentences, response data, and final actions as learning data. The server stores these records in a database schema designed for model training. In one embodiment, the server anonymizes user identifiers and removes sensitive content by applying text redaction methods to comply with privacy requirements.

The server uses the stored learning data during offline training sessions to refine both the machine learning model and the prompt sentence generation process. The server constructs training examples where inputs include normalized text, state information, and existing schedule context, and labels include correct final actions and desirable prompt patterns. The server uses loss functions that measure divergence between predicted and actual actions, such as cross-entropy loss for discrete action types and mean squared error for temporal offset predictions. The server applies gradient-based optimization methods, such as Adam or stochastic gradient descent, to update model parameters and improve prediction accuracy.

By continuously updating the machine learning model and the prompt sentence generation process using real execution data, the server improves the technical performance of the system over time. Specifically, the server reduces the average number of conflicting actions, shortens the time required to converge on a valid schedule modification, and reduces the number of network round trips to external information processing apparatuses by making more accurate decisions in fewer steps. This feedback-driven adaptation is not limited to automating a human workflow, but rather modifies the internal decision-making behavior of the computer system itself, leading to measurable improvements in computational efficiency and reliability.

In another embodiment, the server adopts a different generative AI model configuration, for example a smaller or on-premise model that uses fewer layers or narrower hidden dimensions, to reduce inference latency on devices with limited computational resources. The server can switch between models based on system load, user subscription level, or latency constraints. In yet another embodiment, the server uses a hybrid architecture in which a local rule-based engine handles simple, well-defined scheduling patterns, and the generative AI model is selectively invoked only when requests are complex or contain ambiguous constraints. This selective invocation reduces computational cost and network load, thereby improving system scalability.

In a further embodiment, the terminal performs part of the natural language preprocessing locally, such as speech-to-text conversion or basic entity extraction, before sending the processed data to the server. The server then applies the same decision-making framework described above. This distribution of processing can reduce network bandwidth usage and improve responsiveness for the user, while still allowing the central server to maintain and update global models and prompt templates.

Through these embodiments, the server, the terminal, and the external information processing apparatus cooperate to implement a concrete technical system that improves over conventional computer-implemented scheduling solutions. The described combination of structured state information, state-aware prompt sentence generation, generative AI inference, deterministic verification, and continuous learning provides specific technical advantages, including higher accuracy of schedule operations, lower conflict rates, faster convergence to feasible solutions, and more efficient use of network and computing resources.

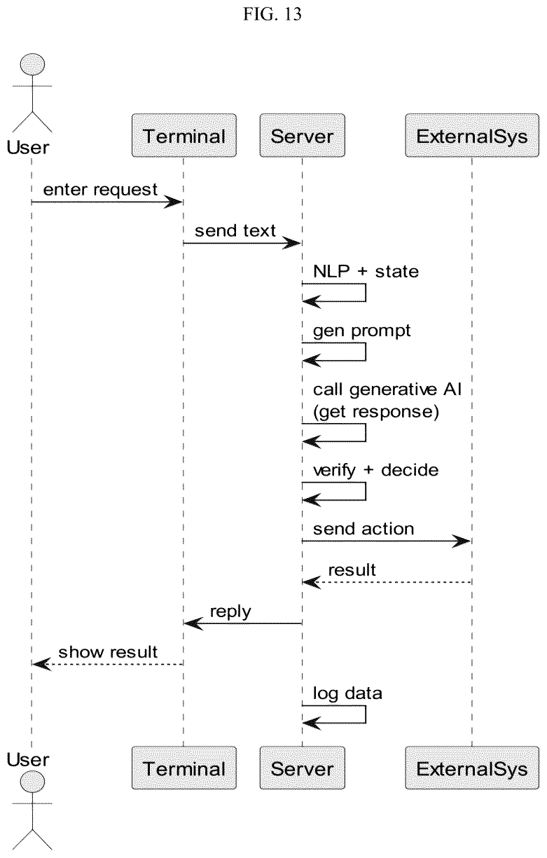

The following describes the processing flow using FIG. 13.

### Step 1:

The user inputs a natural language request or schedule description into the terminal.
The terminal displays a text input field and optionally a microphone button, and the user types or dictates a sentence such as “I want to book a dentist appointment next Tuesday.”
Input: User interaction (keystrokes or speech) captured by the terminal UI components.
Output: A text string representing the user's request stored in the terminal's memory.

### Step 2:

The terminal transmits the text string and associated metadata to the server.
The terminal packages the text, a user identifier, a locale code, and a timestamp into a structured message and sends it via HTTPS to a predefined API endpoint of the server using a network communication module.
Input: The text string and user metadata stored in the terminal.
Output: An HTTP request carrying the text and metadata delivered to the server's network interface.

### Step 3:

The server receives the HTTP request and performs initial validation and normalization of the text data.
The server verifies authentication tokens, checks that mandatory fields are present, and then normalizes the text by applying character encoding normalization, lowercasing, and removal of control characters using a text preprocessing module executed by the processor.
Input: The raw HTTP request containing the text string and metadata.
Output: A normalized text string and a validated request object stored in the server's memory.

### Step 4:

The server executes natural language processing to extract structured elements from the normalized text.
The server tokenizes the text into word or subword units, applies part-of-speech tagging and named entity recognition, and uses a trained neural model to detect intent, event subject, date and time expressions, and constraint phrases. The server computes embeddings for tokens, performs matrix multiplications through neural network layers, and applies softmax functions to produce label probabilities.
Input: The normalized text string.
Output: Structured elements including request content, schedule content, raw temporal expressions, and constraint conditions represented as internal data structures.

### Step 5:

The server resolves temporal expressions into concrete date and time values.
The server uses a datetime resolution module to combine the extracted temporal expressions with the user's time zone and current date. The server calculates specific calendar dates for expressions such as “next Tuesday” and computes start and end times based on default durations or constraint phrases (for example, “two hours” or “30 minutes”), performing arithmetic on timestamp values.
Input: Extracted temporal expressions and user environment information (time zone, current date).
Output: Resolved date and time information as concrete timestamps associated with the schedule content.

### Step 6:

The server retrieves state information for the user from persistent storage.
The server queries a database using the user identifier to obtain user history information, temporal preference information, behavior history information, service usage history information, and existing schedule information, and then derives free-time schedule information by computing gaps between stored events.
Input: The user identifier and database connection parameters.
Output: State information objects containing historical patterns, preferences, and current schedule slots loaded into memory.

### Step 7:

The server determines candidate actions using a deterministic or discriminative model.
The server combines the structured elements from natural language processing and the state information into feature vectors, then inputs these vectors into a machine learning model such as a neural classifier or decision-tree ensemble. The server computes model outputs representing one or more candidate actions (for example, create event, reschedule event) and assigns confidence scores by evaluating the model's output probabilities.
Input: Structured elements from Step 4-5 and state information from Step 6.
Output: A set of candidate actions with associated parameters (proposed times, durations, event types) and confidence scores.

### Step 8:

The server selects or builds a context representation for prompt sentence generation.
The server aggregates the user request, extracted entities, resolved timestamps, user preferences, and candidate actions into a unified context object. The server filters out redundant or low-relevance items and computes summary statistics, such as the number of conflicts with existing events and the distribution of free time slots.
Input: Candidate actions, structured elements, and state information.
Output: A context object containing distilled information to be embedded into a prompt sentence.

### Step 9:

The server generates a prompt sentence for a generative AI model.
The server applies a prompt template and fills placeholders with values from the context object. The server constructs a multi-line text including roles (system, user), explicit constraints, and the goal of the operation, and arranges information in a deterministic order so the same context yields a similar prompt each time.
Input: The context object summarizing the user request and state information.
Output: A prompt sentence as a text string ready to be sent to the generative AI model.

### Step 10:

The server sends the prompt sentence to a generative AI model and performs inference.
The server encodes the prompt sentence into tokens, forwards them through a transformer-based model with multiple attention layers, and computes output token probabilities step by step to generate a response text. The server may communicate with an external AI service over HTTPS or execute the model locally using a model runtime.
Input: The prompt sentence text string.
Output: A response text string produced by the generative AI model, describing proposed operations or parameters.

### Step 11:

The server parses the generative AI response into structured response data.
The server applies deterministic parsing rules and lightweight natural language parsing to identify elements such as event title, start time, end time, event type, and references to existing events. The server maps sentence segments or enumerated instructions in the response text to corresponding fields in internal data structures, and converts any time expressions back into timestamps.
Input: The response text from the generative AI model.
Output: Structured response data representing proposed actions and their parameters.

### Step 12:

The server verifies the structured response data against constraints and independent candidates.
The server compares proposed event times with existing schedule entries by computing overlaps between time intervals, measures violations of user preferences, and checks compliance with rules such as maximum overlap tolerance and working-hour boundaries. The server also compares the response data with candidate actions from the deterministic model to detect large discrepancies.
Input: Structured response data from Step 11, candidate actions from Step 7, and state information from Step 6.
Output: A verification result including validity flags, violation scores, and recommendations for accepting, modifying, or rejecting the proposed actions.

### Step 13:

The server determines a final action by arbitration and optimization.
The server combines confidence scores from the candidate action model with verification scores and applies an objective function, for example minimizing schedule conflicts and changes while maximizing adherence to preferences. The server selects the highest-scoring feasible action or constructs a composite action set in which some parts are taken from the generative AI response and other parts from the deterministic candidates.
Input: Verification results, candidate actions, and structured response data.
Output: A final action object that uniquely specifies what operations should be executed on the external information processing apparatus.

### Step 14:

The server generates operation information for the external information processing apparatus.
The server converts the final action object into a request format defined by the external system, such as an event creation or update request, and populates fields including event title, start time, end time, location, recurrence, and reminder settings. The server maps internal identifiers to external identifiers when modifying or deleting existing events.
Input: The final action object.
Output: Operation information formatted as one or more external service requests.

### Step 15:

The server transmits operation information to the external information processing apparatus and receives processing results.
The server authenticates with the external apparatus, sends create, update, or delete requests via APIs, and waits for responses. The server's network interface and protocol stack handle connection management, encryption, and error retries. The external apparatus returns confirmation data such as event identifiers, updated event details, or error codes.
Input: Operation information and authentication credentials.
Output: Processing result information from the external information processing apparatus.

### Step 16:

The server updates internal state information based on the processing results.
The server writes new or updated event identifiers, times, and attributes into the database, recomputes free-time schedule information by scanning all events and recalculating gaps, and updates user history information to reflect the newly executed operations.
Input: Processing result information and existing state records.
Output: Updated state information stored in persistent storage, ready for subsequent requests.

### Step 17:

The server generates a response message for the user.
The server creates a natural language summary of the final action and the external processing results, formats dates and times according to the user's locale, and may include brief explanations such as why a particular time slot or rescheduling pattern was chosen.
Input: The final action object and processing result information.
Output: A human-readable response message text intended for display on the terminal.

### Step 18:

The server transmits the response message to the terminal.
The server embeds the response message into a structured API response and sends it over HTTPS to the terminal. The server includes status codes indicating success or failure and, if necessary, additional diagnostic messages.
Input: The response message text and status metadata.
Output: An HTTP response carrying the response message delivered to the terminal.

### Step 19:

The terminal displays the response message to the user.
The terminal parses the server's response, extracts the message text, and renders it in the user interface, for example in a dialog or a notification view, optionally highlighting the scheduled or rescheduled events in an embedded calendar view.
Input: The HTTP response from the server.
Output: A visual presentation on the terminal's display, enabling the user to understand the results.

### Step 20:

The server records end-to-end processing artifacts as learning data.
The server stores, in a training data repository, the original text data, the state information snapshot, the generated prompt sentence, the response text and parsed response data, and the final action and verification results. The server links these artifacts with anonymized identifiers and timestamps to support later batch training of models and refinement of prompt templates.
Input: All intermediate data generated in Steps 3 through 17.
Output: Persisted learning data records that can be used to update the machine learning model and prompt sentence generation process in future training cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented assistant systems that handle user requests and schedules typically rely on static, rule-based mappings from recognized text to predefined application programming interface (API) calls. In such architectures, a processor converts user speech to text and performs basic natural language parsing; however, the processor then applies fixed logic to construct downstream API requests. This approach exhibits several technical drawbacks: the request construction logic must be manually coded and updated for each external service, the system is not robust to linguistic variation in user input, and the processing pipeline becomes brittle and difficult to scale as the number of external information processing apparatuses and their interfaces increases. Furthermore, existing systems generally perform sentiment or emotion analysis, if at all, only as an ancillary feature that does not have a deep, integrated influence on how responses are generated at the protocol or message-formation level. As a result, processor resources are not effectively utilized to adapt request generation and response composition to heterogeneous user states and heterogeneous external interfaces in real time.

In addition, in many known architectures, emotion-aware behavior is implemented by hard-coded branches that select between a small set of canned responses. This limits the granularity with which the system can tailor guidance, proposals, or explanations to a user's emotional state, and causes unnecessary duplication of processing logic across different application domains such as schedule management, information retrieval, and task management. The processor expends cycles running multiple, separate formatting and decision modules that are not unified, which can lead to increased latency, higher memory consumption, and reduced throughput when serving many concurrent users. The inability to unify intent understanding, emotion analysis, interface request generation, and user-facing message generation into a single, coherent pipeline also complicates optimization of the processor's execution path and hinders effective caching and load balancing strategies.

Moreover, conventional systems that retrieve inventory information or sales promotion information in response to product scans in a physical environment generally construct user-facing guidance in a procedural manner without leveraging a generative artificial intelligence model as a central formatting and reasoning component. In such systems, a processor simply concatenates fixed templates with database fields, which yields inflexible and often verbose messages. When new types of information (for example, complex promotion conditions or multi-store stock situations) are introduced, the template logic must be extensively rewritten.

This rigid architecture fails to exploit recent advances in generative artificial intelligence models that can dynamically interpret structured data and generate compact, context-aware natural language guidance. From a computer-technology perspective, this results in suboptimal utilization of model inference capabilities, leads to fragmented code paths in the processor, and impairs the ability of the system to maintain low-latency response times while handling diverse information sources.

Accordingly, there is a need for a computer-implemented system and processing architecture in which a processor is configured to (i) unify conversion of multi-modal user inputs into text, (ii) perform integrated natural language understanding and emotion analysis, (iii) automatically derive interface request information for arbitrary external information processing apparatuses by using a generative artificial intelligence model driven by prompt sentences, and (iv) generate explanation information or proposal information for presentation to the user, again by using the same or a coordinated generative artificial intelligence model controlled by structured prompt sentences. There is a further need to technically improve the way the processor conditions the generative model with emotion information and external response information so that the resulting system can dynamically adapt its behavior while reducing the amount of hard-coded control logic. Such improvements to the internal data flow, model invocation pattern, and prompt generation mechanism can reduce complexity of the control program, increase flexibility in supporting new external APIs and new types of guidance, improve cache efficiency for repeated intent patterns, and reduce overall processing latency, thereby improving the functioning of the computer system itself rather than merely automating a business method.

The specific processing by the specific processing unit 290 of the data processing device 12 in Application Example 2 is realized by the following means.

The present invention provides a server comprising a processor configured to convert voice information and character information obtained from a user into text information by using a voice recognition technique and a character input acceptance technique in order to acquire request information or schedule information through interaction with the user, to analyze the text information by using a natural language processing technique and an emotion analysis technique to extract the request information, schedule information, and emotion information, to generate interface request information indicating function call content of an external information processing apparatus by generating a prompt sentence on the basis of an extraction result and by inputting the prompt sentence to a generative artificial intelligence model so as to produce the interface request information, to call, on the basis of the interface request information, an application programming interface of the external information processing apparatus via a communication network to cause the external information processing apparatus to execute at least one of a schedule management process, an information acquisition process, and a task management process and to acquire response information from the external information processing apparatus, to generate explanation information or proposal information on the basis of the response information and the emotion information by generating a further prompt sentence and by inputting the further prompt sentence and the response information to the generative artificial intelligence model so as to produce the explanation information or the proposal information, and to transmit the explanation information or the proposal information to a terminal device so that the explanation information or the proposal information is presented to the user through a display process or a voice output process. This enables a unified and technically improved processing pipeline in which the processor leverages a generative artificial intelligence model, controlled by structured prompt sentences and conditioned on both intent and emotion information, to automatically synthesize external interface requests and user-facing messages, thereby reducing hard-coded control logic, improving adaptability to heterogeneous external application programming interfaces and user states, and enhancing the overall computational efficiency and responsiveness of the computer-implemented assistant system.

The term “user” refers to a human operator who provides input to the system and receives information or services from the system through a terminal device.

The term “terminal device” refers to an information processing apparatus, such as a portable communication device, a stationary computing device, or a display apparatus, configured to acquire input from the user and to present information to the user via a display or audio output.

The term “server” refers to an information processing apparatus, typically including at least one processor, memory, and communication interface, configured to execute programs for processing user inputs, interacting with external information processing apparatuses, and generating information to be provided to the user.

The term “processor” refers to a hardware execution unit, such as a central processing unit or a processing circuit, configured to execute instructions that implement the functions of the system, including recognition processing, analysis processing, generation processing, and communication processing.

The term “voice information” refers to audio data representing speech uttered by the user, including analog or digital signals that can be processed by a voice recognition technique to derive textual content.

The term “character information” refers to user input data representing characters, symbols, or text entered by the user through an input interface such as a keyboard, touch panel, or pointing device.

The term “text information” refers to data in a character-based format representing linguistic content obtained by converting voice information or character information, and used as an object of natural language processing and emotion analysis.

The term “voice recognition technique” refers to a processing technique or algorithm for converting voice information into text information by analyzing acoustic features of the voice information.

The term “character input acceptance technique” refers to a processing technique or interface for accepting and acquiring character information entered by the user through an input device or user interface component.

The term “request information” refers to information representing a desired operation, service, or processing requested by the user, extracted from the text information as a structured representation of user intent.

The term “schedule information” refers to information representing temporal conditions such as dates, times, or time ranges, and associated activities or events requested or referred to by the user.

The term “emotion information” refers to information representing an estimated emotional state of the user, such as an anxious state, a tense state, an excited state, or another affective state, derived by processing the text information or related data.

The term “natural language processing technique” refers to a processing technique or algorithm for analyzing text information to identify linguistic structures, such as tokens, parts of speech, entities, and relationships, and to extract at least request information and schedule information.

The term “emotion analysis technique” refers to a processing technique or algorithm for estimating the emotion information by evaluating the content, wording, and other features of the text information or related signals.

The term “prompt sentence” refers to a text string or structured textual instruction provided as input to a generative artificial intelligence model to control or guide generation of output data, including interface request information, explanation information, or proposal information.

The term “generative artificial intelligence model” refers to a model implemented by a machine learning algorithm configured to generate data, such as text, in response to an input including a prompt sentence and optional structured information, by learning statistical relationships from training data.

The term “interface request information” refers to structured data indicating function call content for an external information processing apparatus, including parameters, operation types, or resource identifiers for an application programming interface.

The term “external information processing apparatus” refers to a computing resource or service, such as a remote server or external system, that exposes an application programming interface and executes processes including schedule management, information acquisition, or task management in response to interface request information.

The term “application programming interface” refers to a set of rules, endpoints, and data formats through which an external information processing apparatus can be requested to perform operations or provide data.

The term “schedule management process” refers to a process executed by an external information processing apparatus for creating, modifying, or deleting schedule entries or events based on schedule information.

The term “information acquisition process” refers to a process executed by an external information processing apparatus for obtaining data, such as informational content, status data, or resource data, in response to an interface request.

The term “task management process” refers to a process executed by an external information processing apparatus for creating, assigning, updating, or tracking tasks or work items.

The term “response information” refers to data returned from an external information processing apparatus in response to an application programming interface call, including status information, resource information, or error information.

The term “explanation information” refers to information generated for presentation to the user that explains results, states, or operations in natural language or another understandable format based on response information and optionally emotion information.

The term “proposal information” refers to information generated for presentation to the user that proposes actions, options, or recommendations based on response information and optionally emotion information.

The term “display process” refers to processing performed by a terminal device to present information on a visual output unit, such as a display panel, according to display control data provided from the server.

The term “voice output process” refers to processing performed by a terminal device to convert text or other data into audio signals and output the audio signals through a speaker or audio output unit.

The term “constraint condition” refers to a rule or requirement appended to a prompt sentence to restrict or guide the type, tone, content, or style of output to be generated by the generative artificial intelligence model.

The term “article identification information” refers to information that uniquely or specifically identifies an article, such as a product code, barcode, or other identifier obtained from an article identification information acquisition unit.

The term “article identification information acquisition unit” refers to a functional component or device configured to acquire article identification information, for example by reading a code, capturing an image, or receiving data from a sensor.

The term “inventory management information storage device” refers to a storage resource, such as a memory or database, configured to store inventory information including stock quantities, locations, and availability states of articles.

The term “sales promotion information storage device” refers to a storage resource configured to store information regarding promotions, discounts, campaigns, or other sales-related conditions associated with articles.

The term “inventory information” refers to information representing a status of stock of an article, including at least a quantity, availability, or storage location.

The term “sales promotion information” refers to information representing sales-related conditions, such as discounts, bundles, or campaign rules, applicable to an article.

The term “guidance information” refers to explanation information or proposal information that is specifically related to an article and that is presented to the user to guide purchasing, selection, or understanding of the article.

In one embodiment, a server cooperates with at least one terminal device operated by a user. The server includes a processor, a memory, a non-transitory storage medium storing program instructions, and a communication interface connected to a communication network. The terminal includes an input unit such as a microphone and a character input device, an output unit such as a display and a speaker, a local processor, a memory, and a communication interface.

The server executes a program that is stored in the storage medium. The program defines processing modules including a voice recognition interface module, a character input reception module, a natural language processing module, an emotion analysis module, a prompt generation module, a generative AI inference module, an interface request construction module, an external API communication module, and a response composition module. The server configures these modules to operate on structured data objects stored in the memory, such as text objects, intent objects, emotion state objects, interface request objects, and user-facing message objects.

The terminal acquires voice information by using the microphone and an audio capture subsystem provided by an operating system, such as an audio framework in a portable communication device. The terminal converts the captured analog voice signal into a digital signal and compresses the digital signal into audio packets. The terminal transmits the audio packets to the server or to an external speech-to-text service. Alternatively, the terminal performs client-side voice recognition by using a voice recognition technique provided by a software library, and transmits the resulting text information to the server.

The terminal acquires character information by using a character input device such as a touchscreen-based keyboard, a physical keyboard, or another pointing device. The terminal converts key events or touch events into a character string and transmits the character string as text information to the server. The terminal associates metadata such as a user identifier, a device identifier, a timestamp, and a language code with the text information and includes the metadata in a structured message transmitted to the server.

The server receives the text information and metadata through the communication interface and stores the received data in the memory. The server uses the natural language processing module, implemented for example with a general-purpose programming language in conjunction with a natural language processing library such as a tokenization and part-of-speech tagging library, to convert the text information into a token sequence, a part-of-speech tag sequence, and a dependency parse tree. The server then constructs an intermediate representation including intent information, schedule information, slot values, and contextual features.

The server applies an emotion analysis technique to the text information. In one example, the server uses a sentiment analysis library or a neural network-based classifier implemented with a machine learning framework. The emotion analysis module receives as input the token sequence and optional acoustic features such as speaking rate or amplitude statistics. The emotion analysis module outputs emotion information representing an emotional label, such as “anxious,” “tense,” or “excited,” and a confidence value. The server stores the emotion information in association with the intent information and the schedule information in an emotion state object.

The server generates a prompt sentence for a generative AI model by using the prompt generation module. The server constructs the prompt sentence by inserting the intent information, the schedule information, and the emotion information into a template or by applying a rule-based prompt generation algorithm. The server arranges the prompt sentence as a sequence of text segments including an instruction portion, a context portion, and a constraint portion. For example, the server generates a prompt sentence such as:
“You are an API assistant. Convert the following user intent into a structured API request. User intent: create an event ‘dentist appointment’ tomorrow at 3 p.m. in the primary schedule. Output only a valid API request.”

In another example, when the server generates user-facing explanation information, the server prepares a prompt sentence such as:
“The user requested a dentist appointment and appears anxious. The appointment has been scheduled for tomorrow at 3 p.m. Generate a short, supportive confirmation message that reassures the user.”

The server executes a generative AI inference module that interfaces with a generative AI model. In one embodiment, the generative AI model is a transformer-based neural network including an input embedding layer, multiple self-attention layers, feed-forward layers, and an output projection layer. The model parameters are stored in the memory and are loaded into the processor's execution environment. The model receives as input the prompt sentence tokenized into discrete tokens and represented as numerical embedding vectors. The model computes attention scores between tokens, applies non-linear activation functions, and produces an output sequence of tokens that is decoded into text representing interface request information, explanation information, or proposal information.

The server trains the generative AI model in an offline phase by using a training dataset consisting of pairs of prompt sentences and target outputs. The server uses a supervised learning strategy with a loss function such as cross-entropy between predicted token sequences and target token sequences. The server updates model parameters by using an optimization algorithm such as stochastic gradient descent or a variant such as Adam. The server may perform data augmentation by paraphrasing input sentences, automatically generating schedule variants, or modifying emotion labels to increase robustness. The server does not modify the model parameters during normal inference operation; instead, the server uses the trained model to perform generation given new prompt sentences.

The server constructs interface request information by parsing the output of the generative AI model. The interface request information is represented as a structured data object in the memory, such as a key-value mapping including fields like “operation,” “resource,” “parameters,” and “authentication token.” The server validates that the interface request information conforms to schema constraints corresponding to a target application programming interface. If necessary, the server post-processes the interface request information by normalizing field values, resolving time zones, or inserting default values.

The server uses the external API communication module to transmit the interface request information to an external information processing apparatus via the communication network.

The external information processing apparatus may host a schedule management function, an information retrieval function, a task management function, or an inventory management function. The server maps the interface request information to a concrete protocol such as a RESTful request with a path, query parameters, and a request body, or another standardized interface format. The server manages authentication by attaching credentials, tokens, or keys as required by the external apparatus.

The server receives response information from the external information processing apparatus, decodes the response into structured data, and stores the structured data in the memory. The server then generates explanation information or proposal information by calling the generative AI model again with a further prompt sentence. The further prompt sentence includes at least a summary of the response information and the emotion information. For example, the server generates a prompt sentence such as:
“The following schedule update has been completed: an event ‘dentist appointment’ tomorrow at 3 p.m. has been added. The user is anxious. Generate a concise message confirming the update and providing reassurance.”

The server provides the prompt sentence and response information to the generative AI model, and the model outputs a user-facing message in natural language. The server stores the generated explanation information or proposal information as a message object and transmits the message object to the terminal.

The terminal receives the explanation information or proposal information and presents it to the user through the display or the speaker. The terminal converts the received text into a graphical representation or into audio by using a text-to-speech engine. The terminal ensures that the presentation respects formatting instructions or layout metadata generated by the server, such as emphasis of urgent information or display of promotion-related fields.

In another embodiment, the server uses article identification information acquired by a terminal. The terminal reads a code or captures an image of an article by using a camera unit or a code scanner, and transmits the article identification information to the server. The server accesses an inventory management information storage device and a sales promotion information storage device, both implemented as storage resources such as databases, to retrieve inventory information and sales promotion information associated with the article.

The server then constructs a prompt sentence that includes the inventory information and the sales promotion information and provides this prompt sentence to the generative AI model to generate guidance information for the article. For example, the server generates a prompt sentence such as:
“The user scanned a product. Stock is low (5 units remaining). There is a 10% discount and a bundle offer with a complementary product. Generate a short message explaining the stock status and the promotion to the user.”

The server receives as output guidance information that describes to the user that stock is limited and that a discount and bundle offer are available. The terminal then displays this guidance information on a screen near the article or on a personal device, thereby directly linking the computer-implemented processing with a physical article in a real environment.

The server improves computer technology by unifying the generation of external interface request information and user-facing messages through a single generative AI model controlled by structured prompt sentences. The server reduces the amount of hard-coded mapping logic traditionally required to convert textual user requests into different external API calls. By representing interface requests as outputs of a generative AI model that has been trained on variations of API patterns, the server achieves higher flexibility and robustness against variations in natural language expressions without increasing program complexity. The server reduces maintenance overhead and improves extensibility because new external APIs can be supported primarily by adjusting prompt sentences and training data rather than rewriting low-level instruction sequences.

The server further improves processing efficiency by integrating emotion information into the prompt generation process. The server does not merely select between static templates; instead, the server encodes emotion information as explicit constraints within the prompt sentences. This configuration allows the generative AI model to dynamically adjust the style and content of generated messages. Because the model handles style adaptation internally through its learned parameters, the server reduces branching and duplication in the control code, lowering instruction cache misses and pipeline stalls in the processor. This yields faster average response times and lower resource usage compared to an architecture that uses many separate template modules.

The server also improves accuracy of schedule management and interface request generation.

The server uses the natural language processing module to extract structured schedule information and validates that the generated interface request objects directly reflect the extracted schedule information. The combination of deterministic parsing and generative inference reduces misinterpretation of temporal expressions by using a two-stage process: first extracting normalized time values, then generating request fields that must match those values. The server can implement consistency checks comparing parsed schedule information and generated interface parameters, thereby reducing errors in event creation and improving reliability.

The server can adopt alternative configurations of the generative AI model. In one variation, the server uses a sequence-to-sequence transformer pre-trained on general language data and fine-tuned on domain-specific mappings between intents and API calls. In another variation, the server uses a multi-task architecture where a shared encoder processes the text information and separate decoders generate interface requests and user-facing messages. The server can also implement a smaller distilled model for on-premises deployment to reduce latency. These alternative configurations share the feature that prompt sentences control model behavior and that structured results are generated as explicit outputs for further processing.

The terminal can be implemented as a portable communication device, a kiosk, a head-mounted display, or another form of terminal. The terminal can cache prompt templates or partial results to reduce communication load. For example, the terminal can locally generate certain fixed portions of messages while the server generates variable portions. The terminal can also pre-process audio signals to extract features such as pitch or speaking rate, and transmit these features along with text to improve emotion estimation. This distributed processing reduces network bandwidth usage and shares computing load between the server and terminals.

The user interacts with the system by providing natural language requests and by scanning articles or selecting interface elements. The user does not need to know details of external APIs or data structures. The system converts the user's high-level input into concrete, low-level API calls and corresponding explanations. Because the server continuously applies the same generative AI model and prompt framework to all supported services, the system can maintain consistent behavior and performance even as new services are added.

In these embodiments, the system does not simply automate a human workflow; instead, the system alters the internal operation of the computer by introducing a prompt-controlled generative AI processing layer that replaces large volumes of static, rule-based code, thereby improving computational efficiency, scalability, and accuracy in generating both machine-readable interface requests and human-readable guidance. The described architecture, data structures, and learning methods enable one skilled in the art to implement the claimed system on general-purpose or specialized hardware to achieve the stated technical effects.

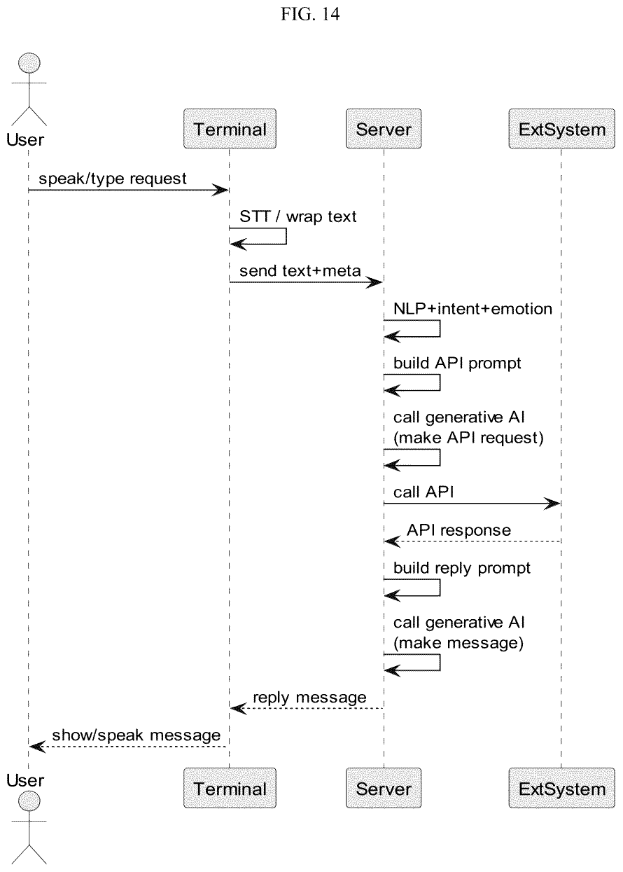

The following describes the processing flow using FIG. 14.

### Step 1:

User provides an instruction.
User speaks a request such as “Please book a dentist appointment tomorrow at 3 p.m.” into a microphone of the terminal or types a similar request on a character input interface.
Input: Natural-language utterance (audio) or natural-language text from the user.
Output: Audio signal data or character string representing the user's instruction.
Terminal converts physical speech into a digital audio signal, frames the signal into packets, and forwards either the audio or the typed text toward the server.

### Step 2:

Terminal converts voice to text and packages user input.
Terminal, when receiving audio, applies a voice recognition technique (for example, by calling a speech-to-text service) to convert the audio signal into a text string. Terminal attaches metadata such as a user identifier, device identifier, timestamp, and language code to the text string and constructs a structured message.
Input: Audio signal data or raw character string.
Output: Structured message including text information and metadata.
Terminal performs signal processing (feature extraction and acoustic model decoding when done locally), generates the text, encapsulates it with metadata in a message object, and sends this message to the server via a communication interface.

### Step 3:

Server receives and stores text information.
Server accepts the structured message from the terminal through a network interface and parses the message header and body. Server extracts the text information and metadata and stores them in memory as a text object associated with a new processing session.
Input: Structured message including text information and metadata.
Output: Text object and associated session record stored in server memory.
Server performs data validation, checks character encoding, and initializes internal identifiers for the session.

### Step 4:

Server performs natural language preprocessing.
Server applies a natural language processing technique to the text information. Server tokenizes the text into a sequence of tokens, assigns part-of-speech tags, and builds a syntactic or dependency representation.
Input: Text object (user instruction as a string).
Output: Token sequence, part-of-speech tag sequence, and dependency structure stored in an intermediate representation.
Server executes parsing algorithms from a language processing library and writes the resulting linguistic annotations into associated data structures.

### Step 5:

Server extracts intent information and schedule information.
Server analyzes the intermediate representation to identify intent information (for example, “create event,” “query information,” “manage task”) and schedule information (dates, times, time ranges, and event labels).
Input: Token sequence and dependency structure.
Output: Intent object containing intent type and parameters, and schedule object containing normalized time data and event description.
Server applies pattern-matching rules, entity recognition models, and normalization logic to convert expressions such as “tomorrow at 3 p.m.” into an absolute timestamp and associates it with the detected intent.

### Step 6:

Server estimates emotion information.
Server applies an emotion analysis technique to the text information and optionally to prosodic features if they are available from the terminal. Server classifies the user's emotional state (for example, anxious, tense, excited, neutral) and computes a confidence score.
Input: Text object and optionally acoustic feature vector.
Output: Emotion state object including an emotion label and confidence value.
Server feeds the tokenized text into an emotion classifier, computes feature vectors, runs the classifier network, and stores the resulting label and score.

### Step 7:

Server constructs a first prompt sentence for interface request generation.
Server creates a prompt sentence that describes the intent information and schedule information in a controlled textual format. Server may insert constraints about output format (for example, “Output only a valid API request”) and internal rules (for example, “Use 24-hour time”).
Input: Intent object and schedule object.
Output: Prompt sentence for the generative AI model to generate interface request information.
Server concatenates fixed instruction phrases with variable fields extracted from the intent and schedule objects to form a single coherent prompt sentence string.

### Step 8:

Server provides the first prompt sentence to the generative AI model and generates interface request information.
Server feeds the prompt sentence to a generative AI model and executes model inference. Server receives as generated output a structured representation describing interface request information, such as an operation name, resource path, and parameter values required by an external application programming interface.
Input: Prompt sentence for interface request generation.
Output: Interface request object including API operation type, endpoint pattern, and parameter fields.
Server tokenizes the prompt sentence, maps tokens to embeddings, runs neural network layers (attention, feed-forward), decodes the output sequence into text or structured content, and converts the generated text into a structured interface request object.

### Step 9:

Server validates and normalizes the interface request information.
Server checks that the interface request object conforms to schema constraints for the target external information processing apparatus. Server resolves missing values, verifies parameter ranges, and normalizes dates and times into the format expected by the external interface.
Input: Interface request object generated by the generative AI model.
Output: Validated and normalized interface request object.
Server compares field definitions to a stored schema, performs type and range checks, corrects formats (for example, converting local time to UTC), and updates the object in memory.

### Step 10:

Server calls external application programming interfaces.
Server maps the validated interface request object to a specific network request, such as a RESTful HTTP request. Server includes headers, authentication tokens, and a request body constructed from the interface request fields, and transmits the request to an external information processing apparatus.
Input: Validated interface request object.
Output: Response information received from at least one external information processing apparatus.
Server opens a network connection, writes the request data onto the connection, waits for a response, parses response headers and bodies, and stores the parsed data as response information objects.

### Step 11:

Server aggregates and structures response information.
Server collects response information from one or more external information processing apparatuses. Server extracts relevant fields such as success status, resource identifiers, event times, inventory levels, or promotion details, and composes a unified response data structure.
Input: Raw response information objects from external apparatuses.
Output: Aggregated response object containing normalized status and data fields.
Server maps external field names to internal field names, merges multiple responses if needed, and stores a single aggregated representation for downstream processing.

### Step 12:

Server constructs a second prompt sentence for explanation or proposal generation.
Server generates another prompt sentence that includes at least a summary of the aggregated response object and the emotion state object. Server includes instructions describing style, conciseness, and empathy level. For example, server generates a prompt such as: “The appointment has been created for tomorrow at 3 p.m. The user is anxious. Generate a short, reassuring confirmation.”
Input: Aggregated response object and emotion state object.
Output: Prompt sentence for the generative AI model to generate explanation information or proposal information.
Server converts structured response fields into readable text segments, appends descriptions of emotion states, and adds style constraints to form a single prompt sentence string.

### Step 13:

Server provides the second prompt sentence to the generative AI model and generates explanation or proposal information.
Server sends the second prompt sentence and, when necessary, additional context to the generative AI model. Server receives generated text that constitutes explanation information or proposal information addressed to the user.
Input: Prompt sentence for explanation or proposal generation.
Output: User-facing message object containing explanation information or proposal information.
Server encodes the prompt sentence, runs the generative model to sample output tokens, decodes tokens into text, and stores the resulting text along with formatting tags as a message object.

### Step 14:

Server prepares a response to the terminal.
Server wraps the user-facing message object and any additional metadata such as identifiers of created events, tasks, or articles into a structured server response. Server may add layout hints (for example, title and body separation) for rendering.
Input: User-facing message object and associated metadata.
Output: Structured server response message destined for the terminal.
Server serializes the message object into a transmission format, sets appropriate headers, and queues the response in an outgoing message buffer.

### Step 15:

Terminal receives and presents the explanation or proposal information.
Terminal receives the server response through its communication interface and parses the structured data. Terminal extracts the explanation information or proposal information and displays the text on a display unit or converts it into audio using a text-to-speech engine, optionally emphasizing key elements such as time and date.
Input: Structured server response message including explanation or proposal information.
Output: Visual or audio output presented to the user.
Terminal binds text to user interface components, updates the screen or initiates playback through a speaker, and may log the interaction locally for history or undo functions.

### Step 16:

User confirms, modifies, or issues additional instructions.
User reviews the displayed or spoken information and, if necessary, provides further input such as confirmation, correction, or another request.
Input: Visual or audio output from the terminal and the user's subsequent reaction.
Output: New utterance or text input that can be processed as a new instruction.
User operates input controls or speaks again, and the terminal captures this new input and begins another processing cycle starting from the initial steps.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

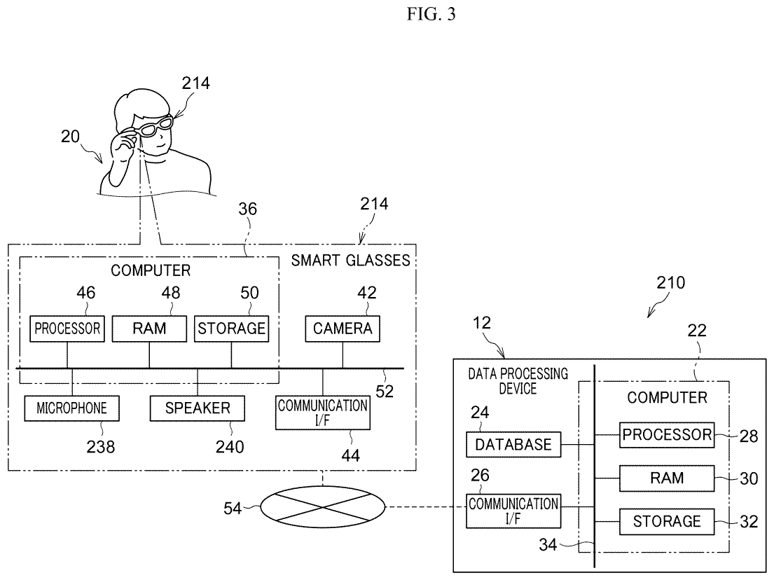

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

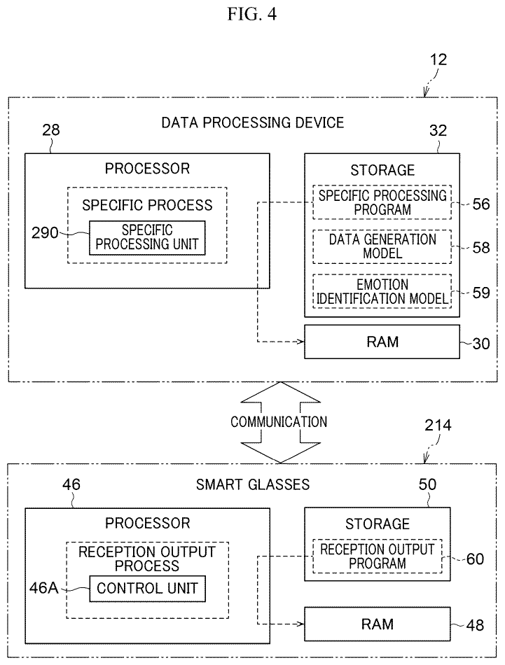

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

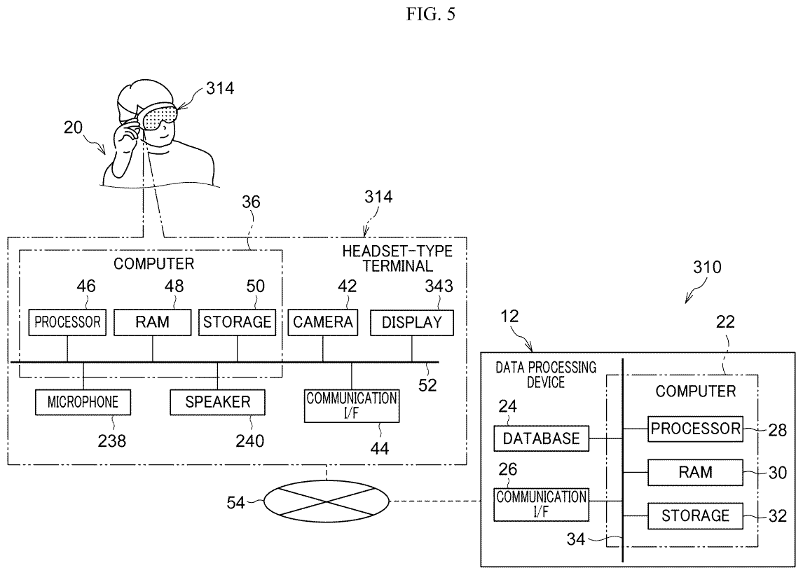

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

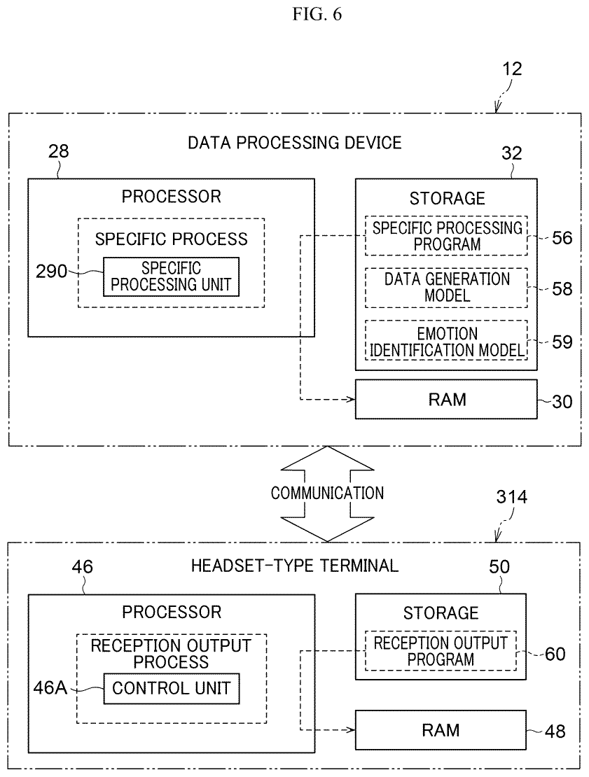

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

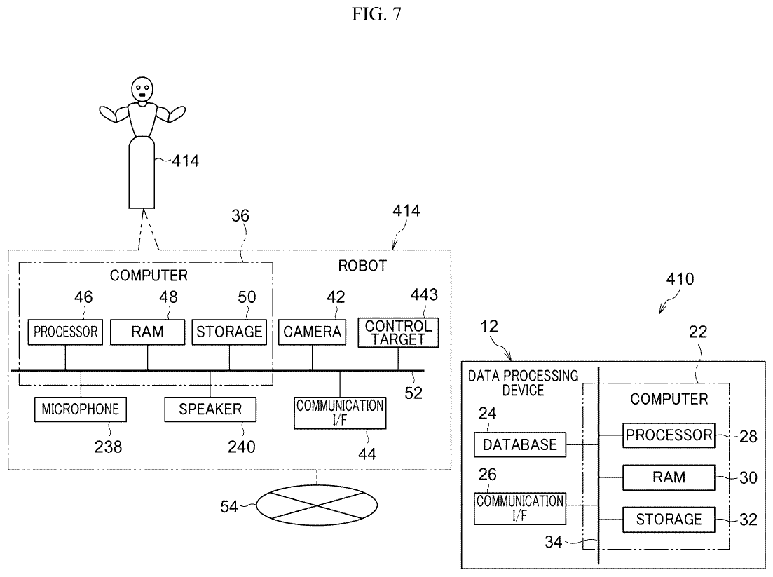

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

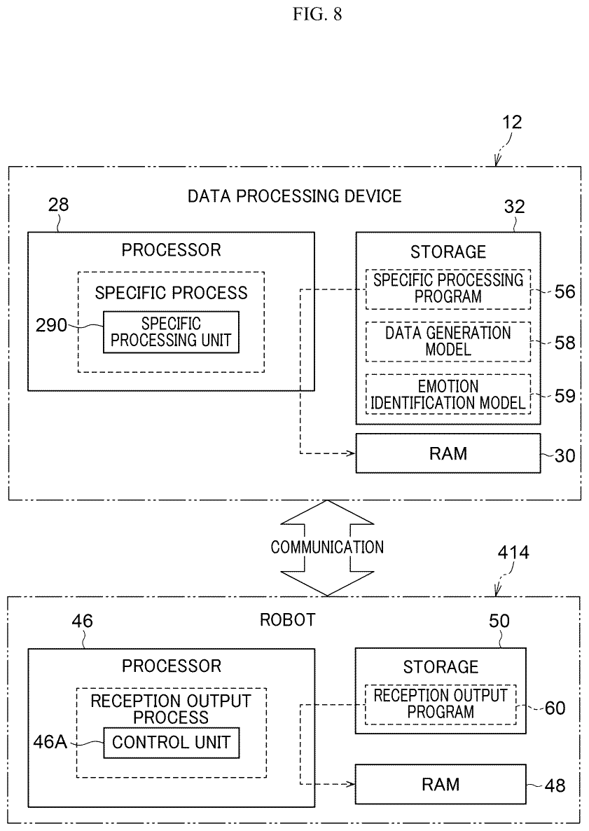

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

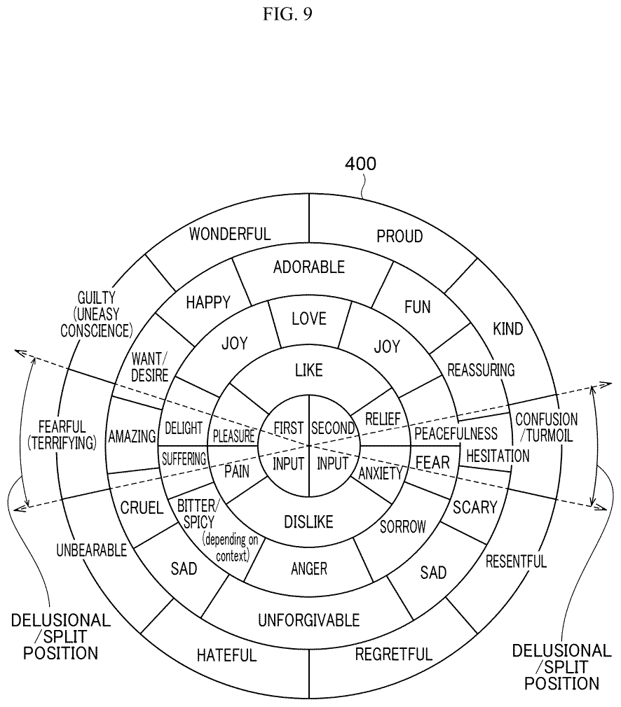

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

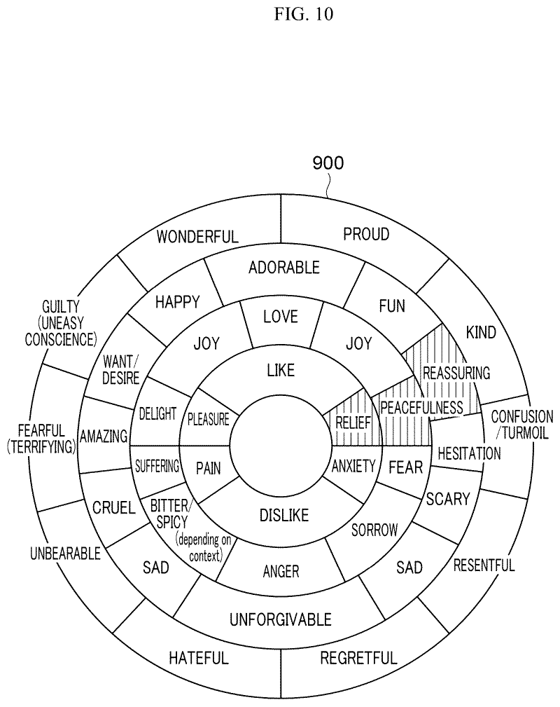

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
(check other similar patent)
wherein the processor is configured to
receive, via an information processing terminal operated by a user, input information expressed in natural language,
preprocess the input information by removing unnecessary elements contained in the input information and normalizing character information, thereby generating analysis text information,
generate an instruction sentence including the analysis text information, transmit the instruction sentence as a prompt sentence to a generative information processing model executed in an external information processing apparatus, and obtain, as a response result, structured information representing a semantic interpretation and extracted information of the analysis text information,
extract schedule information including time information and event information from the structured information, convert the schedule information into an internal data format, and generate a schedule information object,
store the schedule information object in a storage device or generate notification information based on the schedule information object and transmit the notification information to the information processing terminal, and
cooperate with an external information processing service based on the schedule information object so as to perform at least one of schedule registration, notification transmission, and resource reservation.

### Supplementary 2

The system according to supplementary 1,
wherein the processor is configured to estimate an emotional state of the user based on the structured information, and to control at least one of response content and proposal content in accordance with the estimated emotional state.

### Supplementary 3

The system according to supplementary 1,
wherein the processor is configured to, when it is determined from the analysis text information that the schedule information is missing or ambiguous, generate an additional prompt sentence including instruction content for specifying a missing or ambiguous portion,
transmit the additional prompt sentence to the generative information processing model,
receive a query sentence from the generative information processing model, transmit the query sentence to the information processing terminal to obtain additional input from the user, and regenerate the schedule information object based on an analysis result including the additional input.

### Application Example 1

### Supplementary 1

A system comprising a processor,
wherein the processor is configured to
acquire voice information in a dialogue with a user from a terminal and convert the voice information into text information by using a speech recognition technique,
analyze the text information and extract request information and schedule information of the user or of another person with whom the user is interacting, and generate structured information including the request information and the schedule information by using a natural language processing technique,
generate a prompt sentence for causing a generative artificial intelligence model to generate commodity information or service information to be proposed to the other person, on the basis of the structured information,
obtain response information including the commodity information or the service information from the generative artificial intelligence model and associate the response information with sales target information to generate presentation information, and
transmit the presentation information to the terminal and display the presentation information in real time on a display device of the terminal to support a proposal action to the other person by the user.

### Supplementary 2

The system according to supplementary 1,
wherein the processor is configured to
analyze emotion information from the text information or from the structured information, and change content of the prompt sentence or content of the presentation information in accordance with the emotion information.

### Supplementary 3

The system according to supplementary 1,
wherein the processor is configured to
perform information cooperation with an external apparatus including a schedule management apparatus or a business processing apparatus on the basis of the prompt sentence or the presentation information, and execute registration or modification of reservation information, updating of schedule information, or allocation of task information.

### Example 2

### Supplementary 1

A system comprising a processor,
wherein the processor is configured to
acquire, from a terminal, natural language input including a request or schedule from a user, and generate text data including the request or schedule,
analyze the text data by using natural language processing to extract request content, schedule content, date and time information, and constraint conditions,
obtain state information including at least user history information and environment information based on the extracted request content, schedule content, date and time information, and constraint conditions, and determine candidate actions to be executed by using the state information,
generate a prompt sentence for input to a generative AI model, based on the candidate actions, the state information, and the text data,
execute an inference process by the generative AI model using the prompt sentence, and obtain response data from the generative AI model, the response data including at least a part of the candidate actions as concrete operation procedures or operation parameters,
verify the response data, and determine a final action based on a verification result and predetermined determination conditions, by adopting at least one of an output result of the generative AI model and an action candidate obtained by a machine learning model or rule-based determination,
transmit operation information corresponding to the final action to an external information processing apparatus, and cause the external information processing apparatus to register or update reservation information or schedule information by using an information management function or a schedule management function of the external information processing apparatus,
generate a response message to the user based on processing result information acquired from the external information processing apparatus, and transmit the response message to the terminal, and
record the text data, the state information, the prompt sentence, the response data, and the final action as learning data, and update at least one of the machine learning model and a prompt sentence generation process for the generative AI model based on the learning data.

### Supplementary 2

The system according to supplementary 1,
wherein the processor is configured to
treat the state information as including at least temporal preference information of the user, behavior history information, service usage history information, and free-time schedule information, and generate the prompt sentence by embedding the state information as structured data in the prompt sentence so that the generative AI model outputs an action plan reflecting time constraints and priorities specific to the user.

### Supplementary 3

The system according to supplementary 1,
wherein the processor is configured to
compare start times and end times of candidate schedules included in the response data from the generative AI model with existing schedule information acquired from the external information management function, evaluate the candidate schedules based on a degree of time overlap and predetermined priority rules, and select, as the final action, at least one of new registration, modification, or deletion of a schedule according to an evaluation result.

### Application Example 2

### Supplementary 1

A system comprising a processor,
wherein the processor is configured to
convert voice information and character information obtained from a user into text information by using a voice recognition technique and a character input acceptance technique in order to acquire request information or schedule information through interaction with the user,
analyze the text information by using a natural language processing technique and an emotion analysis technique to extract the request information, the schedule information, and emotion information,
generate interface request information indicating a function call content of an external information processing apparatus corresponding to the request information or the schedule information by generating a prompt sentence on the basis of an extraction result and by generating the interface request information by inputting the prompt sentence to a generative artificial intelligence model,
call, on the basis of the interface request information, an application programming interface of the external information processing apparatus via a communication network to cause the external information processing apparatus to execute at least one of a schedule management process, an information acquisition process, and a task management process, and acquire response information from the external information processing apparatus,
generate explanation information or proposal information to be presented to the user on the basis of the response information and the emotion information by generating a prompt sentence and by generating the explanation information or the proposal information by inputting the prompt sentence and the response information to the generative artificial intelligence model, and
transmit the explanation information or the proposal information to a terminal device so that the explanation information or the proposal information is presented to the user through a display process or a voice output process.

### Supplementary 2

The system according to supplementary 1,
wherein the processor is configured to
when the emotion information indicates an anxious state, a tense state, or an excited state, add to the prompt sentence a constraint condition instructing a response that provides reassurance,
an additional schedule management process for reducing a burden, or an entertainment information providing process, and input the prompt sentence including the constraint condition to the generative artificial intelligence model so as to adjust the explanation information or the proposal information in accordance with an emotional state of the user.

### Supplementary 3

The system according to supplementary 1,
wherein the processor is configured to
refer, on the basis of article identification information acquired from an article identification information acquisition unit, to an inventory management information storage device and a sales promotion information storage device, include acquired inventory information and sales promotion information in a prompt sentence to be input to the generative artificial intelligence model in order to generate the explanation information or the proposal information, and cause the explanation information or the proposal information to be presented by the terminal device as guidance information relating to an article.

What is claimed is:

1. A system comprising:
circuitry configured to:
receive, via a communication interface coupled to a packet-switched network, input information expressed in natural language from a terminal device, and preprocess the input information by removing unnecessary elements and normalizing character information to generate analysis text information;
construct a prompt sentence by embedding the analysis text information into an instruction template, transmit the prompt sentence to a generative AI model, and obtain structured information representing a semantic interpretation and extracted information comprising at least an intent type, time information, and event information;
apply a speech recognition model to audio data received from the terminal device to generate character string data, and apply a natural language processing model to the character string data to extract request information and schedule information;
generate a schedule information object comprising time information and event information converted into an internal data format based on the structured information, and store the schedule information object in a storage device;
generate notification information based on the schedule information object and transmit the notification information to the terminal device via the communication interface; and
cooperate with an external processing service via the communication interface based on the schedule information object to perform at least one of schedule registration, task assignment, and information provision.

2. The system according to claim 1, wherein the circuitry is configured to apply an emotion recognition model to at least one of the character string data and auxiliary data received from the terminal device to generate an emotional state representation, and adjust a service proposal generated for transmission to the terminal device based on the emotional state representation.

3. The system according to claim 2, wherein the circuitry is configured to apply a sentiment analysis model to the character string data to identify linguistic emotional indicators, and combine the identified linguistic emotional indicators with biosignal data received from the terminal device in the emotion recognition model.

4. The system according to claim 3, wherein the circuitry is configured to select a service proposal type from a predefined set of service categories based on the emotional state representation, and generate a service proposal prompt sentence incorporating the service proposal type for input to the generative AI model.

5. The system according to claim 4, wherein the circuitry is configured to transmit the service proposal to the terminal device together with the notification information, and receive a user selection response from the terminal device indicating acceptance or modification of the service proposal.

6. The system according to claim 1, wherein the circuitry is configured to apply a named entity recognition model to the structured information to identify time entities, location entities, and participant entities, and use the identified entities to populate corresponding fields of the schedule information object.

7. The system according to claim 6, wherein the circuitry is configured to acquire availability data from an external schedule management service via the communication interface for each identified participant entity, and incorporate the availability data in an updated schedule information object.

8. The system according to claim 1, wherein the circuitry is configured to apply a prosody analysis model to the audio data received from the terminal device to extract pitch contours, speaking rate, and energy features, and apply a voice-based emotion classifier to the extracted prosodic features to generate an emotional state representation.

9. The system according to claim 8, wherein the circuitry is configured to combine the emotional state representation from the voice-based emotion classifier with a text-based sentiment score derived from the character string data to generate a composite emotional state representation for service proposal adjustment.

10. The system according to claim 1, wherein the circuitry is configured to apply a context tracking model to a sequence of analysis text information items received during a dialog session, maintain a context representation across multiple turns, and incorporate the context representation in the prompt sentence for each subsequent turn.

11. The system according to claim 10, wherein the circuitry is configured to apply a coreference resolution model to the sequence of analysis text information items to identify references to entities mentioned in prior turns, and resolve the references to populate fields of the generated structured information.

12. The system according to claim 1, wherein the circuitry is configured to apply a task classification model to the intent type extracted from the structured information to identify a task category from a predefined set comprising schedule management, information retrieval, and task assignment, and select an external processing service for cooperation based on the identified task category.

13. The system according to claim 12, wherein the circuitry is configured to generate a cooperation instruction prompt incorporating the schedule information object and the identified task category, and transmit the cooperation instruction prompt to the selected external processing service via the communication interface.

14. The system according to claim 1, wherein the circuitry is configured to apply an article identification processing model to identification information received from the terminal device, retrieve inventory information and promotional information from a storage device based on the article identification information, and incorporate the inventory information and promotional information in the prompt sentence to generate guidance information.

15. The system according to claim 14, wherein the circuitry is configured to transmit guidance information comprising at least item description data and availability data to the terminal device via the communication interface for presentation to the user.

16. The system according to claim 1, wherein the circuitry is configured to monitor execution status of task assignments transmitted to the external processing service, receive status update data via the communication interface, and generate updated notification information for transmission to the terminal device based on the status update data.

17. The system according to claim 16, wherein the circuitry is configured to apply a completion verification model to the status update data to determine whether a task assignment has been completed, and generate a summary message for transmission to the terminal device upon task completion.

18. A system comprising:
circuitry configured to:
receive, via a communication interface coupled to a packet-switched network, audio data and text data from a terminal device, apply a speech recognition model to the audio data to generate character string data, and preprocess the character string data to generate analysis text information;
construct a prompt sentence embedding the analysis text information into an instruction template, transmit the prompt sentence to a generative AI model, and obtain structured information comprising an intent type, time information, and event information;
apply a prosody analysis model to the audio data to extract prosodic features, apply an emotion recognition model to the prosodic features and linguistic emotional indicators extracted from the character string data to generate an emotional state representation;
generate a schedule information object based on the structured information and store it in a storage device, generate a service proposal adjusted based on the emotional state representation, and cooperate with an external processing service via the communication interface to perform at least one of schedule registration, task assignment, and information provision; and
transmit notification information and the service proposal to the terminal device via the communication interface.

19. The system according to claim 18, wherein the circuitry is configured to apply a context tracking model to maintain a context representation across multiple dialog turns, incorporate the context representation in subsequent prompt sentences, and apply a coreference resolution model to resolve entity references across turns.

20. A method comprising:
receiving, via a communication interface coupled to a packet-switched network, input information expressed in natural language from a terminal device, and preprocessing the input information by removing unnecessary elements and normalizing character information to generate analysis text information;
constructing a prompt sentence by embedding the analysis text information into an instruction template, transmitting the prompt sentence to a generative AI model, and obtaining structured information representing a semantic interpretation and extracted information comprising at least an intent type, time information, and event information;
applying a speech recognition model to audio data received from the terminal device to generate character string data, and applying a natural language processing model to the character string data to extract request information and schedule information;
generating a schedule information object comprising time information and event information converted into an internal data format based on the structured information, and storing the schedule information object in a storage device;
generating notification information based on the schedule information object and transmitting the notification information to the terminal device via the communication interface; and
cooperating with an external processing service via the communication interface based on the schedule information object to perform at least one of schedule registration, task assignment, and information provision.
